(19) United States
(12) Patent Application Publication
(10) Pub. No.: US 2026/0069040 A1
(43) Pub. Date: Mar. 12, 2026

(54) SHAPE MEMORY ALLOY (SMA) ACTUATORS FOR LUMBAR SUPPORT AND MASSAGE

(71) Applicant: Toyota Motor Engineering & Manufacturing North America, Inc., Plano, TX (US)

(72) Inventors: Michael Paul Rowe, Pinckney, MI (US); Erin Rutledge, Tipton, MI (US); Xintong Deng, Plymouth, MI (US); Yufei Zhu, Ypsilanti, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/324,972

(22) Filed: Sep. 10, 2025

Related U.S. Application Data
(60) Provisional application No. 63/692,963, filed on Sep. 10, 2024.

(51) Int. Cl. A47C 7/46; A47C 7/14; F03G 7/06

(52) U.S. Cl. CPC A47C 7/46; A47C 7/144; F03G 7/06143

(57) ABSTRACT

A lumbar support structure includes a first lumbar support and a second lumbar support. At least one of the first and second lumbar supports includes at least one actuator having one or more shape memory material members. The at least one actuator is structured and operatively connected to the other one of the first and second lumbar supports so that an activation input provided to the one or more shape memory material members causes the one or more shape memory material members to contract, thereby causing a distance between a portion of the actuator and the other one of the first and second lumbar supports to increase. A seat incorporating an arrangement of the lumbar support structure and a lumbar support system incorporating an arrangement of the lumbar support structure are also described.

### CROSS-REFERENCE TO RELATED APPLICATIONS

This application claims the benefit of, U.S. Provisional Patent Application Ser. No. 63/692,963, filed on Sep. 10, 2024, which is incorporated herein by reference in its entirety.

### FIELD

The subject matter described herein relates in general to seats and, more particularly, to seats that provide a haptic effect on a user.

### BACKGROUND

Seats (e.g., seats for vehicles) can be contoured and/or can include features to provide support and comfort to a seated user. Some seats can include various ergonomic features to enhance user comfort. Some seats can provide a haptic effect to a user. Further, conventional lumbar support elements (such as lumbar support pillows or cushions) can be used to facilitate comfortable and ergonomic seating. However, a user seated in the seat may have little or no control over the lumbar support force provided by conventional lumbar support elements.

### SUMMARY

In one aspect of the arrangements described herein, a lumbar support structure is provided. The lumbar support structure includes a first lumbar support and a second lumbar support. At least one of the first and second lumbar supports includes at least one actuator having one or more shape memory material members. The at least one actuator is structured and operatively connected to the other one of the first and second lumbar supports so that an activation input provided to the one or more shape memory material members causes the one or more shape memory material members to contract, thereby causing a distance between a portion of the actuator and the other one of the first and second lumbar supports to increase.

In another aspect of the arrangements described herein, a lumbar support system is provided. The lumbar support system includes a lumbar support structure including at least one actuator having one or more shape memory material members. The at least one actuator is structured so that an activation input provided to the one or more shape memory material members causes the one or more shape memory material members to contract, thereby causing an increase in a lumbar support force generated by the actuator. The system also includes a processor and a memory communicably coupled to the processor. The memory stores a control module including computer-readable instructions that when executed by the processor cause the processor to control provision of the activation input to the one or more shape memory material members.

### BRIEF DESCRIPTION OF THE DRAWINGS

FIG. 1 is an example of a seat incorporating elements of a lumbar support structure in accordance with an arrangement described herein.

FIG. 2 is an example of a lumbar support system incorporating a lumbar support structure in accordance with an arrangement described herein.

FIG. 3A shows an example of a first actuator suitable for use according to arrangements herein, shown in a non-activated condition.

FIG. 3B shows the first actuator of FIG. 3A in an activated condition.

FIG. 4A shows an example of a second actuator suitable for use according to arrangements herein, shown in an activated condition.

FIG. 4B shows the first actuator of FIG. 4A in an activated condition.

FIG. 5 is a schematic side cross-sectional view of a back portion of a seat including one arrangement of a lumbar support structure including at least a pair of actuators, shown mounted inside the back portion of a seat.

FIG. 6A is the schematic view of FIG. 5 showing a first actuator in an activated condition and an associated second actuator in a non-activated condition.

FIG. 6B is an example of a method of operating the lumbar support structure of FIG. 5 in the manner shown in FIG. 6A.

FIG. 7A is the schematic view of FIG. 5 showing the first actuator in an activated condition and the associated second actuator in an activated condition.

FIG. 7B is an example of a method of operating the lumbar support structure of FIG. 5 in the manner shown in FIG. 7A.

FIG. 8A is the schematic view of FIG. 5 showing the first actuator in a non-activated condition and the associated a second actuator in an activated condition.

FIG. 8B is an example of operating the lumbar support structure of FIG. 5.

FIG. 9 is an example of a user interface for an actuator.

FIG. 10A shows an actuator in accordance with another arrangement described herein, shown in a non-activated condition.

FIG. 10B shows the actuator of FIG. 10A in an activated condition.

FIG. 11 shows an example of one method of switching an electrical power source between separate shape memory material members incorporated into a single actuator.

FIG. 12A is a schematic cross-sectional side view of a back portion of a seat including a lumbar support structure in accordance with another arrangement described herein, shown mounted inside a seat and prior to activation of an actuator of the lumbar support structure.

FIG. 12B is the schematic cross-sectional side view of FIG. 12A, showing the lumbar support structure after activation of the actuator.

FIG. 13 is a schematic cross-sectional side view of a back portion of a seat including a lumbar support structure in accordance with yet another arrangement described herein, shown mounted inside a seat.

### DETAILED DESCRIPTION

In arrangements described herein, a lumbar support structure is provided. The support structure includes a first lumbar support and a second lumbar support. At least one of the first and second lumbar supports includes at least one actuator having one or more shape memory material members. The at least one actuator is structured and operatively connected to the other one of the first and second lumbar supports so that an activation input provided to the one or more shape memory material members causes the one or more shape memory material members to contract, thereby causing a distance between a portion of the actuator and the other one of the first and second lumbar supports to increase. A seat incorporating an arrangement of the lumbar support structure and a lumbar support system incorporating an arrangement of the lumbar support structure are also described.

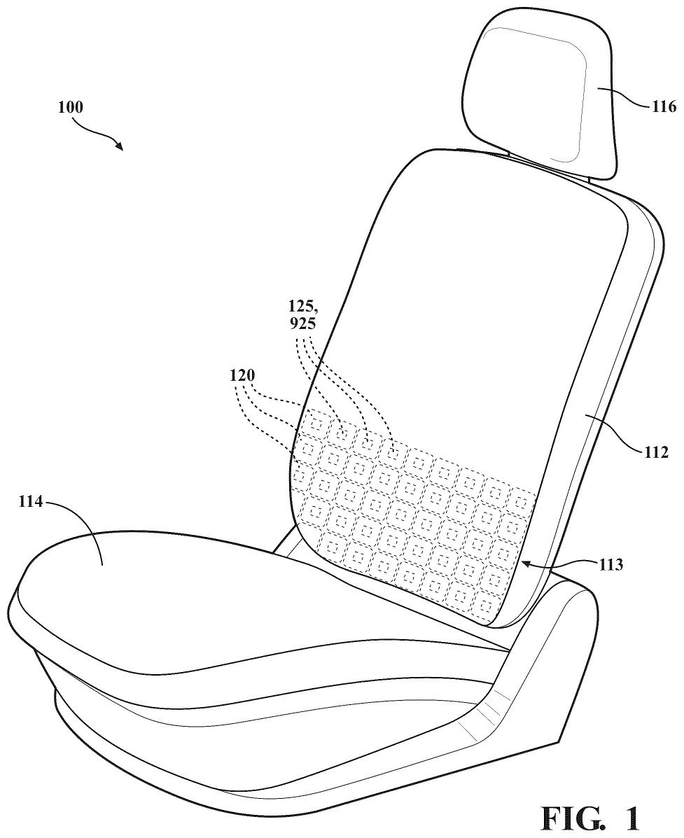

Detailed arrangements are disclosed herein; however, it is to be understood that the disclosed arrangements are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various arrangements are shown in FIGS. 1-13, but the arrangements are not limited to the illustrated structure or application. In addition, similar reference characters in different but similar views may refer to similar elements in the different views.

It will be appreciated that for simplicity and clarity of illustration, where appropriate, reference numerals have been repeated among the different figures to indicate corresponding or analogous elements. In addition, numerous specific details are set forth in order to provide a thorough understanding of the arrangements described herein. However, it will be understood by those of ordinary skill in the art that the arrangements described herein can be practiced without these specific details.

FIG. 1 is an example of a seat incorporating elements of a lumbar support structure in accordance with an arrangement described herein. Referring to FIG. 1, an example of a seat 100 is shown. In one or more arrangements, the seat 100 can be a vehicle seat. The seat 100 can be any type of vehicle seat, now known or later developed. The seat 100 can be structured for any users or vehicle occupants, such for a driver and/or for a passenger. The seat will be described herein with respect to a vehicle seat, but it will be appreciated that arrangements are not limited to vehicle seats. Indeed, the seat 100 can be an office chair, a chair, a massage chair, a gaming chair, a recliner, or any other seat structure, now known or later developed. The seat 100 can have any suitable configuration. For instance, the seat 100 can include a back portion 112 and a seat portion 114. The back portion 112 and/or the seat portion 114 can include bolsters. In some arrangements, the seat 100 can include a headrest 116 and/or arm rests.

The seat 100 can include one or more actuators 120 in accordance with one or more arrangements described herein. The one or more actuators can be operatively positioned relative to one or more surfaces or portions of the seat 100. The one or more surfaces can be a surface of the back portion 112, a surface of the seat portion 114, a bolster of the back portion 112, a bolster of the seat portion 114, headrest 116, an arm rest, or any combination or subset thereof.

In some arrangements, there can be a single actuator 120 associated with the seat. In other arrangements, there can be a plurality of actuators associated with the seat 100. When actuated, the one or more actuators can cause the surface(s) or portion(s) of the seat 100 to morph into a different configuration and/or the one or more actuators can provide a force or a physical sensation to a portion of a seat occupant's body that is in operative contact with the seat 100. “Operative contact” includes direct physical contact as well as indirect contact, such as through an intermediate element (e.g., portions of the seat 100 such as upholstery, padding, cushioning, etc.) and/or the clothing of a seat occupant, for example.

The actuator(s) 120 can be operatively positioned relative to the seat 100. “Operatively positioned relative to” means that the actuators are positioned in a location that, when activated, provide a physical sensation to (or a force exerted on) a person sitting in the seat 100. Referring to FIG. 1, in one or more arrangements, the actuator(s) 120 can be located within a portion of the seat 100. For instance, the actuator(s) 120 can be located within the back portion 112, within the seat portion 114, within the bolster of the back portion 112, within the bolster of the seat portion 114, within the headrest 116, within one or more arm rests, or any combination or subset thereof.

In one or more arrangements, there can be one or more actuators 120 located in a lumbar region 113 of the back portion 112. In this context, the “lumbar portion” of the seat is a portion of the seat that reside opposite (and be structured to support) at least a portion of the lumbar region of a seat occupant's back when the occupant is seated. The lumbar region of the seat may be structured to support at least a portion of the lumbar region of a seat occupant's back.

In arrangements in which there are a plurality of actuators 120, the plurality of actuators 120 can be substantially identical to each other. Alternatively, one or more of the actuators 120 can be different from the other actuators 120 in one or more respects, such as size, shape, configuration, structure, actuation effect, etc. The plurality of actuators 120 can be distributed in any suitable manner with respect to the lumbar region 113 of the seat 100. In some instances, the plurality of actuators 120 can be arranged in rows and columns. In such instances, the actuators 120 in a row or in a column can be adjacent to each other. Alternatively, there can be a spacing between at least some of the actuators 120 in the row or column. In some instances, the plurality of actuators 120 can be arranged in a plurality of discrete areas, which may or may not be spaced apart. In some arrangements described herein, the actuator(s) 120 may include first actuator(s) 120a and second actuator(s) 120b.

When there is a plurality of rows of the actuators 120, the rows can, in some arrangements, have the same quantity of actuators, types of actuators, distribution of actuations, arrangement of actuators, or other aspect. However, in other arrangements, when there is a plurality of rows of actuators 120, the rows can be different from each other in one or more respects, including any of those noted herein. The plurality of rows of the actuators 120 can be adjacent to each other. Alternatively, the rows of the actuators 120 can be spaced apart.

When there is a plurality of columns of the actuators 120, the columns can, in some arrangements, have the same quantity of actuators, types of actuators, distribution of actuations, arrangement of actuators, or other aspect. However, in other arrangements, when there is a plurality of columns of actuators 120, the columns can be different from each other in one or more respects, including any of those noted herein. The columns of rows of the actuators 120 can be adjacent to each other. Alternatively, the columns of the actuators 120 can be spaced apart.

In some arrangements, there can be a single actuator 120 operatively positioned relative to the lumbar region 113. The single actuator 120 can be provided in any suitable location. In some instances, the single actuator 120 can span a portion of the width of the lumbar region 113. In some instances, the single actuator 120 can span at least a majority of the width of the lumbar region 113. In some instances, the single actuator 120 can span the entire width of the lumbar region 113. In some instances, the single actuator 120 can span a portion of the height of the lumbar region 113. In some instances, the single actuator 120 can span a majority of the height of the lumbar region 113. In some instances, the single actuator 120 can span the entire height of the lumbar region 113. In some arrangements, the single actuator 120 operatively positioned relative to the lumbar region 113 can be the only actuator associated with the seat 100.

In some arrangements, as shown in FIG. 1, a plurality of actuators 120 can be operatively positioned relative to the lumbar region 113. The plurality of actuators 120 can be provided in any suitable location. In some instances, the plurality of actuators 120 can span a portion of the width of the lumbar region 113. In some instances, the plurality of actuators 120 can span a majority of the width of the lumbar region 113. In some instances, the plurality of actuators 120 can span the entire width of the lumbar region 113. In some instances, the plurality of actuators 120 can span a portion of the height of the lumbar region 113. In some instances, the plurality of actuators 120 can span a majority of the height of the lumbar region 113. In some instances, the plurality of actuators 120 can span the entire height of the lumbar region 113. In some arrangements, the plurality of actuators 120 operatively positioned relative to the lumbar region 113 can be the only actuators associated with the seat 100. Any number of actuators 120 may be incorporated into the seat structure.

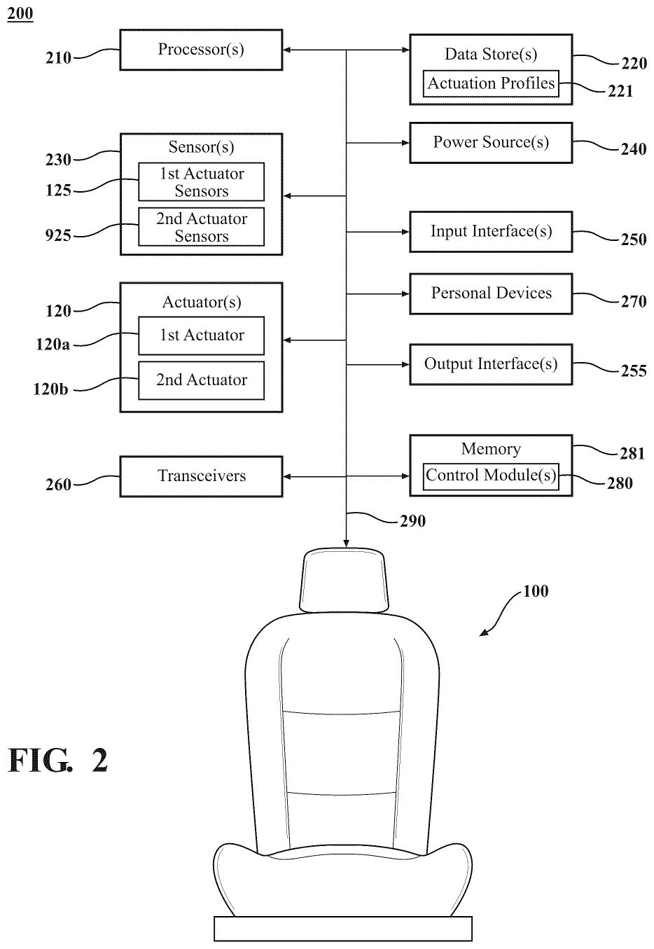

FIG. 2 is an example of a lumbar support system 200 for actuation of a seat including a lumbar support structure in accordance with an arrangement described herein. In some arrangements, the system 200 can be used in connection with a vehicle. As used herein, “vehicle” means any form of transport, including motorized or powered transport. In one or more implementations, the vehicle can be an automobile. While arrangements will be described herein with respect to automobiles, it will be understood that arrangements are not limited to automobiles. In some implementations, the vehicle may be a watercraft, an aircraft, spacecraft, or any other form of transport. Moreover, arrangements described herein are not limited to vehicles.

The system 200 can include various elements. Some of the possible elements of the system 200 are shown in FIG. 2 and will now be described. It will be understood that it is not necessary for the system 200 to have all of the elements shown in FIG. 2 or described herein. The system 200 can have any combination of the various elements shown in FIG. 2. Further, the system 200 can have additional elements to those shown in FIG. 2. In some arrangements, the system 200 may not include one or more of the elements shown in FIG. 2. Further, while the various elements may be located on or within a vehicle, it will be understood that one or more of these elements can be located external to the vehicle. Thus, such elements are not located on, within, or otherwise carried by the vehicle. Further, the elements shown may be physically separated by large distances. Indeed, one or more of the elements can be located remote from the vehicle, such an on a remote server or cloud-based server.

In addition to one or more seats 100 and one or more of the actuators 120, the system 200 can include one or more processors 210, one or more data stores 220, one or more sensors 230, one or more power sources 240, one or more input interfaces 250, one or more output interfaces 255, one or more transceivers 260, one or more personal device(s) 270, and/or a memory 281 storing one or more control modules 280. Each of these elements will be described in turn below.

As noted above, the system 200 can include one or more processors 210. “Processor” means any component or group of components that are configured to execute any of the processes described herein or any form of instructions to carry out such processes or cause such processes to be performed. The processor(s) 210 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 210 can include at least one hardware circuit (e.g., an integrated circuit) configured to carry out instructions contained in program code. In arrangements in which there is a plurality of processors 210, such processors can work independently from each other or one or more processors can work in combination with each other. The processor(s) may be configured to carry out instructions relating to any of actuators 120 and elements thereof, including any and all of the first actuators 120a and the second actuators 120b (described in greater detail below).

The system 200 can include one or more data stores 220 for storing one or more types of data. The data store(s) 220 can include volatile and/or non-volatile memory. Examples of suitable data stores 220 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 220 can be a component of the processor(s) 210, or the data store(s) 220 can be operatively connected to the processor(s) 210 for use thereby. The term “operatively connected,” as used throughout this description, can include direct or indirect connections, including connections without direct physical contact.

In some arrangements, the data store(s) 220 can store one or more actuation profiles. The actuation profiles can include instructions for activating one or more of the actuator(s) 120 (including one or more of any associated first actuators 120a and any associated second actuators 120b) and/or other actuators in a specified manner. The actuation profiles can include activation patterns, activation sequences, activation zones, activation regions, activation times, activation of individual actuators or groups of actuators, etc. The actuation profiles can be created by an end user, a seat manufacturer, a vehicle manufacturer, or some other entity. In some instances, one or more actuation profiles can be received from a remote source. In some arrangements, one or more actuation profiles can be directed to providing lumbar support to a seat occupant.

The system 200 can include one or more sensors 230. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 200 includes a plurality of sensors 230, the sensors can work independently from each other. Alternatively, two or more of the sensors can work in combination with each other. In such case, the two or more sensors can form a sensor network. The sensor(s) 230 can be operatively connected to the processor(s) 210, the data store(s) 220, and/or other elements of the system 200 (including any of the elements shown in FIG. 2).

The sensor(s) 230 can include the sensor(s) 125 described below. In addition, the sensor(s) 230 can include any suitable type of sensor, now known or later developed, that can acquire information or data about the seat 100 or a seat occupant. For instance, the sensor(s) 230 can include weight sensors, seat position sensors, seat angle sensors, occupant position sensors, occupant presence sensors, etc. In one or more arrangements, the sensor(s) 230 can be used to detect the presence of an occupant in the seat 100.

In one or more arrangements, the seat 100 can include a one or more sensors 125. In some arrangements, the sensor(s) 125 can be operatively positioned with respect to a respective one of the first actuator(s) 120a. The sensor(s) 125 can be part of a feedback control loop for the first actuator(s) 120a. For instance, the sensor(s) 125 can be used to help to maintain the first actuator(s) 120a in a particular condition or configuration. In some arrangements, the sensor(s) 125 can be configured to detect, directly or indirectly, changes in the force applied to the lumbar region of seat occupant.

In one or more arrangements, the sensor(s) 125 can be flex sensors. The flex sensors can be any suitable type of flex sensor, now known or later developed. The flex sensors can be configured to change resistance when flexed. The flex sensors can be operatively positioned with respect to associated ones of the first actuator(s) 120a. In some instances, the flex sensors can be operatively positioned on or within associated ones of the first actuator(s) 120a. Thus, when a first actuator(s) 120a is activated or deactivated such that it morphs, the morphing of the first actuator(s) 120a can act upon an associated flex sensor so as to change a resistance in the flex sensor, which can be used to determine changes in a level of lumbar support provided to a seat occupant.

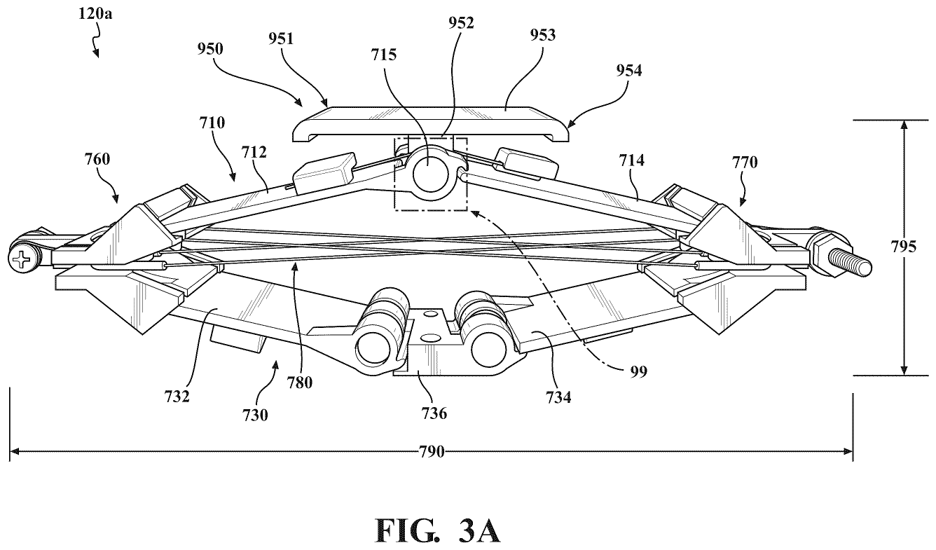

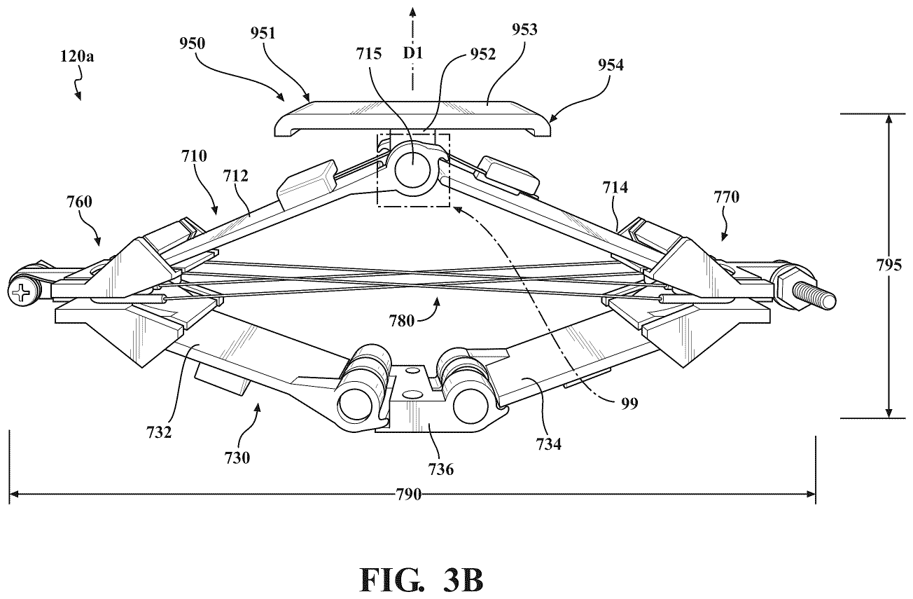

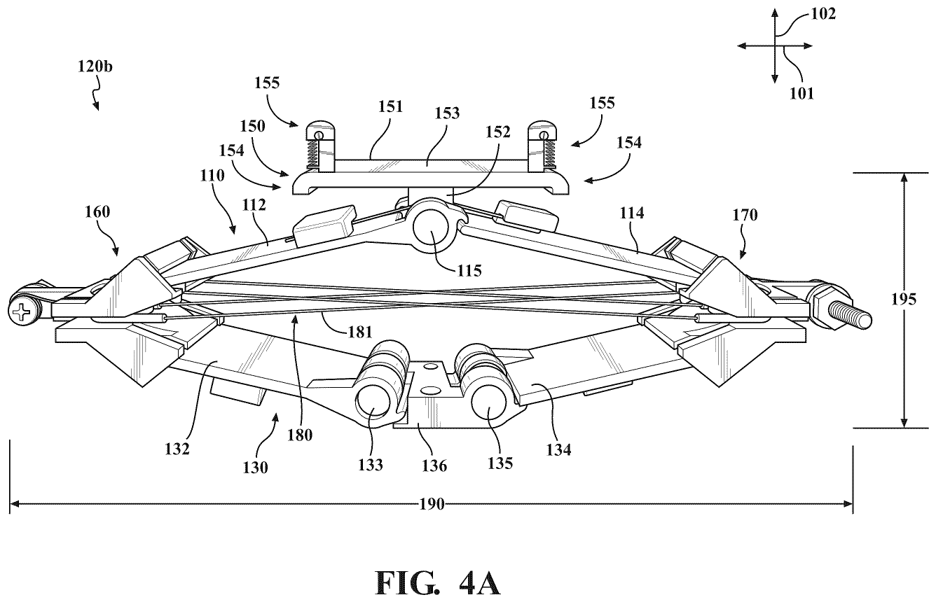

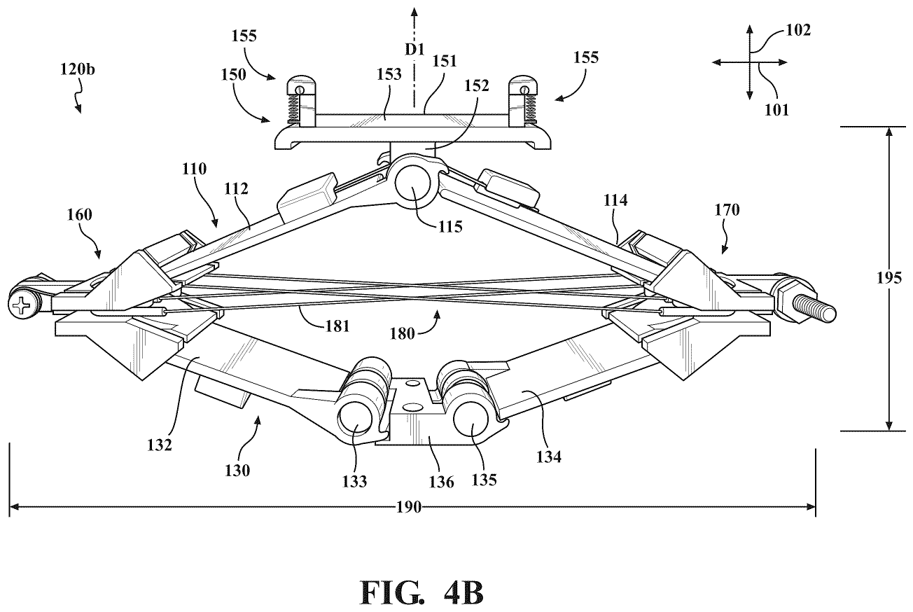

In one or more arrangements, the sensor(s) 125 can be rotational position sensors. The rotational position sensors can be configured to transform mechanical rotary movements and measurements into electrical signals. The rotational position sensors can be any suitable type of rotational position sensors, now known or later developed. In some instances, the rotational position sensors can be operatively positioned on or within associated ones of the first actuator(s) 120a. Thus, when a first actuator 120a is activated or deactivated such that it morphs, the morphing of the first actuator 120a can act upon the rotational position sensors so as to change their output electrical signals, which can be used to determine changes in a level of lumbar support provided to a seat occupant. For example, an increase in the output electrical signal of a rotational position sensor may indicate a corresponding increase in an angle between portions 712 and 732 of first actuator 120a of FIGS. 3A and 3B, thereby indicating an increase in a second or height dimension 795 (in direction D1) of the first actuator 120a to provide a greater degree of lumbar support. FIGS. 3A-4B show some non-limiting examples of first and second actuators 120a, 120b suitable for incorporation into actuators 120 for use in an arrangement of a lumbar support structure described herein.

In one or more arrangements, the seat 100 can include a one or more sensors 925. In some arrangements, the sensor(s) 925 can be operatively positioned with a respect to respective ones of the second actuator(s) 120b. The sensor(s) 925 can be part of a feedback control loop for the second actuator(s) 120b. For instance, the sensor(s) 925 can be used to help to maintain the second actuator(s) 120b in a particular condition/configuration or to otherwise execute an assigned actuation profile. In some arrangements, the sensor(s) 925 can be configured to detect, directly or indirectly, changes in the force applied to the lumbar region of seat occupant.

In one or more arrangements, the sensor(s) 925 can be flex sensors. The flex sensors can be any suitable type of flex sensor, now known or later developed. The flex sensors can be configured to change resistance when flexed. The flex sensors can be operatively positioned with respect to associated ones of the second actuator(s) 120b. In some instances, the flex sensors can be operatively positioned on or within associated ones of the second actuator(s) 120b. Thus, when a second actuator(s) 120b is activated or deactivated such that it morphs, the morphing of the second actuator(s) 120b can act upon the flex sensor so as to change resistance, which can be used to determine changes in a level of lumbar support provided to a seat occupant.

In one or more arrangements, the sensor(s) 925 can be rotational position sensors. The rotational position sensors can be configured to transform mechanical rotary movements and measurements into electrical signals. The rotational position sensors can be any suitable type of rotational position sensors, now known or later developed. In some instances, the rotational position sensors can be operatively positioned on or within associated ones of the first actuator(s) 120a. Thus, when a second actuator 120b is activated or deactivated such that it morphs, the morphing of the second actuator 120b can act upon the rotational position sensors so as to change their output electrical signals, which can be used to determine changes in a level of lumbar support provided to a seat occupant. For example, an increase in the output electrical signal of a rotational position sensor may indicate a corresponding increase in an angle between portions 112 and 132 of second actuator 120b of FIGS. 4A and 4B, thereby indicating an increase in a second or height dimension 195 of the second actuator 120b (in direction D1) to provide a greater degree of lumbar support.

As noted above, the system 200 can include one or more power sources 240. The power source(s) 240 can be any power source capable of and/or configured to energize the actuator(s) 120, as will be described later. For example, the power source(s) 240 can include one or more batteries, one or more fuel cells, one or more generators, one or more alternators, one or more solar cells, and combinations thereof. The power source(s) 240 can be any suitable source of electrical energy.

The system 200 can include one or more input interfaces 250. An “input interface” includes any device, component, system, element or arrangement or groups thereof that enable information/data to be entered into a machine. The input interface(s) 250 can receive an input from a vehicle occupant (e.g. a driver or a passenger). Any suitable input interface 250 can be used, including, for example, a keypad, gesture recognition interface, voice recognition interface, display, touch screen, multi-touch screen, button, joystick, mouse, trackball, microphone and/or combinations thereof.

The system 200 can include one or more output interfaces 255. An “output interface” includes any device, component, system, element or arrangement or groups thereof that enable information/data to be presented to a vehicle occupant (e.g. a person, a vehicle occupant, etc.). The output interface(s) 255 can present information/data to a vehicle occupant. The output interface(s) 255 can include a display. Alternatively or in addition, the output interface(s) 255 may include an earphone and/or speaker. Some components of the system 200 may serve as both a component of the input interface(s) 250 and a component of the output interface(s) 255.

The system 200 can include one or more modules, at least some of which will be described herein. The modules can be stored in a memory 281 communicably coupled to the processor(s) 210. The modules can be implemented as computer-readable instructions or computer readable program code that, when executed by a processor, implements one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively or in addition, one or more data stores 220 may contain such instructions. In some arrangements, the module(s) can be located remote from the other elements of the system 200.

In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 200 can include one or more control modules 280. The control module(s) 280 can include profiles and logic for controlling the actuators 120, including any constituent first actuators 120a and second actuators 120b. The control module(s) 280 can use profiles, parameters, or settings loaded into the control module(s) 280 and/or stored in the data store(s) 220, such as the actuation profiles. In some arrangements, the control module(s) 280 can be located remotely from the other elements of the system 200, such as on a remote server, a cloud-based server, or an edge server.

The control module(s) 280 can be configured to cause one or more of the actuator(s) 120 to be activated or deactivated. As used herein, “cause” or “causing” means to make, force, compel, direct, command, instruct, and/or enable an event or action to occur or at least be in a state where such event or action may occur, either in a direct or indirect manner. For instance, the control module(s) 280 can cause the actuator(s) 120 to be selectively activated or deactivated in any suitable manner. For instance, when the actuator(s) 120 include a shape memory material member or other contracting member, the shape memory material member can be heated by the Joule effect by passing electrical current through the shape memory material member. To that end, the control module(s) 280 can be configured to selectively permit, restrict, adjust, alter, and/or prevent the flow of electrical energy from the power source(s) 240 to the one or more shape memory material members of the actuator(s) 120. The control module(s) 280 can be configured to send control signals or commands over a communication network 290 to the shape memory material members or to other elements of the system 200.

The control module(s) 280 can be configured to cause the actuator(s) 120 to be activated or deactivated individually, in one or more groups, or in one or more regions of the seat 100. The control module(s) 280 can be configured to cause the actuator(s) 120 to be activated or deactivated based on various events, conditions, inputs, or other factors. For instance, the control module(s) 280 can be configured to cause the actuator(s) 120 to be activated or deactivated based on a user input. A user can provide an input on the input interface(s) 250. The input can be a command to implement one of the actuation profiles. The input can be a command to activate or deactivate the one or more of the actuators 120 based on the previously used actuation profile or a default actuation profile. In some instances, the input can be a newly defined actuation profile. The user can define parameters, profiles, and characteristics for individual actuators 120 or a plurality of actuators 120.

The control module(s) 280 can be configured to cause one or more first actuator(s) 120a and/or second actuator(s) 120b to be activated or deactivated individually, in one or more groups, or in one or more regions of the seat 100 according to commands received from a user and/or the requirements of one or more associated actuation profiles. In some instances, the control module(s) 280 can be configured to adjust the degree of activation of the actuator(s) 120. For instance, the control module(s) 280 can be configured to cause any of the first actuator(s) 120a and the second actuator(s) 120b to be in an associated activated condition or configuration that corresponds to an activated condition (e.g., extended to a maximum height) of the actuator(s). The control module(s) 280 can be configured to activate the actuator(s) 120 so that one or more of the first actuator(s) 120a and the second actuator(s) 120b is in an activated condition(s) between a respective non-activated condition or configuration and a respective activated condition(s)

An actuator is considered to be “activated” and in an “activated condition” when an activation input has been applied to at least one shape memory material member of the actuator so as to extend the actuator to a maximum height dimension achievable by contraction of the at least one shape memory material member. After reaching this height dimension, the height dimension associated with this activated condition of the actuator may be maintained by any of several methods as described herein. An actuator is considered to be “non-activated” and in an “non-activated condition” when it is not activated. “Activation” of an actuator is the process of bringing the actuator to an activated condition. “Deactivation” of an actuator refers to return of the actuator height dimension to the value it has after shape memory material member(s) controlling the height dimension have cooled to a point where there is no temperature-related contraction of the member due to application of an activation signal (i.e., return of the height dimension to a minimum value of the height dimension). For example, height dimensions of the first and second actuators 120a, 120b described herein are 795 and 195, respectively.

In some arrangements, the control module(s) 280 can cause the first actuator(s) 120a to be activated to provide a desired level of lumbar support to the seat occupant. Such causing can be performed based on a user input. The control module(s) 280 can be configured to cause the first actuator(s) 120a to be morphed into an activated condition that corresponds to the desired lumbar support.

The control module(s) 280 can be configured to maintain an activated condition of the first actuator(s) 120a. Thus, a substantially continuous level of lumbar support can be provided to the seat occupant. The control module(s) 280 can do so in any suitable manner. For instance, the control module(s) 280 can receive sensor data (e.g., from the sensor(s) 125 about the first actuator(s) 120a and from sensor(s) 925 about the second actuator(s).

The control module(s) 280 can be configured to adjust the activated condition of the first actuator(s) 120a and/or the second actuator(s) 120b based on the sensor data. Adjusting the activated condition includes increasing or decreasing the level of activation of one or more of the first actuator(s) 120a and/or 120b so that the desired level of lumbar support to the seat occupant is substantially maintained. The control module(s) 280 can be configured to analyze data or information acquired by the sensor(s) 230 (e.g., sensors 125 or other sensors) to select an activated condition that may be suitable for the user. For instance, the control module(s) 280 can be configured to detect changes in resistance using sensor data from the flex sensors. When such changes are detected, the control module(s) 280 can be configured to adjust the activated condition of the first actuator(s) 120a and second actuator(s) 120b as appropriate so that the desired level of lumbar support is substantially maintained. The control module(s) 280 can be configured to maintain the first and second actuator(s) in activated conditions such that a force applied to the lumbar region of a seat occupant is maintained. Alternative methods and mechanisms may also be used to maintain the activated condition of the first and second actuator(s) 120a, 120b.

As described herein, the control module(s) 280 can be configured to control activation and deactivation and other operations of the second actuator(s) 120b so as to “cycle” the actuator(s) to produce a massaging effect on a seat occupant, consistent with an associated actuation profile. The control module(s) 280 can be configured to control operation of any locking mechanisms (described in greater detail below) incorporated into any of the first and/or second actuators to maintain associated ones of the first and/or second actuators in their respective activated conditions.

The various elements of the system 200 can be communicatively linked to one another or one or more other elements through one or more communication networks 290. As used herein, the term “communicatively linked” can include direct or indirect connections through a communication channel, bus, pathway or another component or system. A “communication network” means one or more components designed to transmit and/or receive information from one source to another. The data store(s) 220 and/or one or more other elements of the system 200 can include and/or execute suitable communication software, which enables the various elements to communicate with each other through the communication network and perform the functions disclosed herein.

The one or more communication networks 290 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

The actuator(s) 120 can be any element or combination of elements operable to modify, adjust and/or alter one or more surfaces or portions of the seat 100 in a manner described herein. In FIG. 1, the actuator(s) 120 are generally represented by a rectangular feature. It will be understood that the actuator(s) 120 can be any suitable type of actuator, now known or later developed. The terms “condition” and “configuration” may be used interchangeably herein with reference to the shape, overall dimensions, and other pertinent characteristics of an actuator when the actuator is an activated condition and also when the actuator is a non-activated condition.

In one or more arrangements, the lumbar support system and an associated lumbar support structure may include one or more first actuator(s) 120a and one or more second actuator(s) 120b. Each of the first and second actuators may be independently controllable and operable to perform associated functions. That is, in arrangements where the first and second lumbar support structures are in the form of separate first and second actuators as described herein, the first and second actuators may be independently operable to vary the degree of lumbar support provided to a seated user.

The first and second actuators 120a, 120b of the actuator(s) 120 may also be controllable to operate simultaneously and synergistically, in cooperation, to achieve a desired end effect (e.g., a specific physical sensation or effect to a person sitting in the seat 100). There can also be any desired number of second actuator(s) connected to a first actuator, depending on actuator size(s) and space limitations in the seat. An actuator may be “actuated” or “activated” by activating either the first actuator, at least one of the second actuator(s), or both the first actuator and at least one of the second actuator(s).

In some arrangements, within a group of actuators incorporated into a seat as shown in FIG. 1, the actuator(s) 120 can be substantially identical to each other. In other arrangements, the actuator(s) 120 can be different from each other in one or more respects, including in any respect described herein. For example, separate ones of actuators 120 may differ in the particular structure and/or operational characteristics of their respective first actuators (i.e., a first actuator of one of actuators 120 may differ in structure and/or operational characteristics from a first actuator in another one of actuators 120). Also, separate ones of actuators 120 may differ in the particular structure and/or operational characteristics of one or more of their respective second actuators (i.e., a second actuator of one of actuators 120 may differ in structure and/or operational characteristics from a second actuator in another one of actuators 120. In addition, in a given actuator 120 incorporating two or more second actuators, a second actuator of given actuator 120 may differ in structure and/or operational characteristics from another second actuator of given actuator 120.

FIGS. 3A-3B show one example of a first actuator 120a suitable for use according to arrangements herein. The basic details of the first actuator 120a will now be described. Additional details of the first actuator 120a are described in U.S. patent application Ser. No. 18/329,217, which is incorporated herein by reference in its entirety. The first actuator 120a shown in FIGS. 3A-3B is merely one example of a suitable actuator in accordance with arrangements described herein and is not intended to be limiting. Actuators suitable for use as a first actuator are described in U.S. patent Publication Ser. Nos. 17/729,522, 18/452,734, 18/453,395, 18/399,026, 18/329,217 and 18/452,343 as well as U.S. Pat. No. 10,960,793, which are incorporated herein by reference in their entireties. Further, it will be appreciated that arrangements described herein are not limited to actuators with contracting member(s) or shape memory material member(s).

In one or more arrangements, the first actuator 120a may be a support actuator. The support actuator may be structured to support one or more second actuator(s) 120b during operation of the second actuator(s). The support actuator may be structured to provide lumbar support to the lumbar region of a user through an intermediate element (e.g., one or more associated second actuator(s) 120b, a resiliently deformable lumbar support element(s), etc.) supported on the first actuator 120a).

In some arrangements, the first actuator(s) 120a can include a contracting member. When an activation input is provided to the contracting member, the contracting member can contract, thereby causing the first actuator 120a to morph into an activated condition in which a dimension (e.g., the height) of the actuator increases. When the activation input to the contracting member is discontinued, the contracting member can expand, thereby causing the first actuator 120a to morph back into a non-activated condition in which the height dimension of the actuator decreases. In some arrangements, the contracting member can be a shape memory material member, which can include shape memory alloys and shape memory polymers. As an example, the contracting member can be a shape memory alloy wire. A non-limiting example of a suitable first actuator is shown in FIGS. 3A-3B, and is described in greater detail herein.

The first actuator 120a can include a first outer body member 710, a second outer body member 730, a first endcap 760, a second endcap 770, and one or more shape memory material member(s) 780. The first outer body member 710 can include a first portion 712 and a second portion 714. The first portion 712 and the second portion 714 can be operatively connected to each other such that the first portion 712 and the second portion 714 can move relative to each other. In one or more arrangements, the first portion 712 and the second portion 714 can be pivotably connected to each other. For example, the first portion 712 and the second portion 714 can be pivotably connected to each other by one or more hinges. The first portion 712 and the second portion 714 can be angled relative to each other. As a result, the first outer body member 710 can have a generally V-shape.

The second outer body member 730 can include a first portion 732, a second portion 734, and a base 736. In one or more arrangements, each of the first portion 732 and the second portion 734 can be pivotably connected to the base 736. For example, the first portion 732 can be pivotably connected to the base 736 by one or more hinges, and the second portion 734 can be pivotably connected to the base 736 by one or more hinges. The first portion 732 and the second portion 734 can be located on opposite sides of the base 736.

The first actuator 120a can include a first endcap 760 and a second endcap 770. The first endcap 760 and the second endcap 770 can be spaced apart. The first actuator 120a can include one or more shape memory material members 780. The shape memory material member(s) 780 can extend between the first endcap 760 and the second endcap 770 in any suitable manner. The shape memory material member(s) 780 can be operatively connected to the first endcap 760 and the second endcap 770.

The first actuator 120a can include a push structure 950. The push structure 950 can be configured to engage other structures, surfaces, or objects. The push structure 950 can focus the force of the first actuator 120a on an intended target object. The push structure 950 can have any suitable size, shape, and/or configuration. In one or more arrangements, the push structure 950 can be substantially T-shaped. In some arrangements, the push structure 950 can include a platform 951 and a stem 952. In some arrangements, the platform 951 can substantially be a rectangular prism, as is shown. In some instances, the platform 951 can have downturned ends 954, as shown. In some instances, the platform 951 can be a plate-like structure. In other arrangements, the platform 951 can be substantially cylindrical, substantially elliptical cylindrical, substantially triangular prismatic, substantially polygonal prismatic, substantially hexagonal prismatic, substantially octagonal prismatic, substantially trapezoidal prismatic, substantially barrel-shaped, or substantially half-barrel shaped, just to name a few possibilities.

The platform 951 can have an engaging surface 953. The engaging surface 953 can be configured to provide a desired actuation effect on an intended target. In some arrangements, the engaging surface 953 can be substantially planar. In some arrangements, the engaging surface 953 can include one or more contours, protrusions, steps, recesses, elements, or other raised or non-planar features. The engaging surface 953 can be configured to create a focal point for the push (or output) force of the first actuator 120a.

The engaging surface 953 can have any suitable size, shape, and/or configuration. For instance, the engaging surface 953 can be substantially rectangular, substantially circular, substantially oval, substantially polygonal, substantially triangular, substantially hexagonal, substantially octagonal, or substantially trapezoidal, just to name a few possibilities. In some arrangements, the engaging surface 953 can be substantially parallel to the shape memory material member(s) 780. In some arrangements, the engaging surface 953 can be angled relative to the shape memory material member(s)/contracting member(s) 780. The engaging surface 953 can have any suitable orientation to achieve a desired actuation force effect.

FIG. 3A shows an example of the first actuator 120a in a non-activated condition. Here, the shape memory material member(s) 780 are not activated. FIG. 3B shows an example of the first actuator 120a in an activated condition. Referring to FIGS. 3A and 3B, after a shape memory material member(s) 780 is heated to the phase transition temperature TSMA of the material, the activated shape memory material member(s) 780 may start to pull the first endcap 760 and the second endcap 770 toward each other as the member(s) contracts. This movement of the first endcap 760 and the second endcap 770 toward each other produces a push force acting in direction D1 and increasing the height dimension 795. When the actuator 120a is incorporated into a lumbar support structure as described herein, the generated push force may be manifested as a lumbar supporting force that is greater than a lumbar supporting force generated by the actuator 120a when the shape memory material member(s) 780 are not energized. The increased lumbar supporting force may be transmitted through and applied by the platform 951. The effects described above may also be produced in the second actuator 120b (FIGS. 4A and 4B) when the second actuator 120b has the same basic structure as the first actuator 120a.

When an activation input (e.g., electrical energy) is provided to the shape memory material member(s) 780, the shape memory material member(s) 780 can contract. This contraction causes the shape memory material member(s) 780 to pull the first endcap 760 and the second endcap 770 toward each other in a direction that corresponds to a first dimension 790. As a result, the first outer body member 710 and the second outer body member 730 can extend outward and away from each other in a direction that corresponds to a second dimension 795. It will be appreciated that, in going from the non-activated condition to the activated condition, the first dimension 790 (i.e., the width dimension) of the first actuator 120a can decrease and/or the second dimension 795 (i.e., the height dimension) of the first actuator 120a can increase. Further, it will be appreciated that the first actuator 120a can deliver a force in a direction that is out of plane or otherwise different from the direction of contraction of the shape memory material member(s) 780. In some arrangements, first actuators of any two separate actuators described herein may have the same or different non-activated positions. Likewise, first actuators of any two separate actuators described herein may have the same or different activated positions. The dimensions 790 and 795 can be substantially perpendicular to each other.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP). A shape memory material member is considered to be “activated” and in an “activated condition” when the member has finished contracting due to elevation of a temperature of the member to a level above the phase transition temperature T_{SMA} of the material, thereby producing an activated condition of the actuator. A shape memory material member is considered to be in a “non-activated condition” when it is not activated.

In one or more arrangements, the shape memory material members can be shape memory material wires. As an example, the shape memory material members can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated condition.

The wire(s) can have any suitable characteristics. For instance, the wire(s) can be high temperature wires with austenite finish temperatures from about 80 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The pulling force of SMA wire(s) can be from about 150 MPA to about 400 MPa. The wire(s) can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members to be moved from a non-activated condition to an activated condition in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni—Ti, or nitinol). One example of a nickel-titanium shape memory alloy is FLEXINOL, which is available from Dynaolloy, Inc., Irvine, California. As a further example, the SMA wires can be made of Cu—Al—Ni, Fe—Mn—Si, or Cu—Zn—Al.

The SMA wire can be configured to increase or decrease in length upon changing phase, for example, by being heated to a phase transition temperature T_{SMA}. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austenite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

Other active materials may be used in connection with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation input.

While the shape memory material members are described, in some implementations, as being wires, it will be understood that the shape memory material members are not limited to being wires. Indeed, it is envisioned that suitable shape memory materials may be employed in a variety of other forms, such as sheets, plates, panels, strips, cables, tubes, or combinations thereof. In some arrangements, the shape memory material members may include an insulating coating.

It should be noted that the shape memory material member(s) 780 can be located substantially entirely within the overall envelope of the first actuator 120a. A portion of the shape memory material member(s) 780 can extend outside of a respective one of the endcaps 760, 770 for operative connection to another conductor and/or power source.

In some arrangements, there can be a single shape memory material member 780. In such case, the shape memory material member 780 can, for example, extend straight across the cavity from the first endcap 760 and the second endcap 770. In another example, the shape memory material member 780 can extend in a serpentine pattern between the first endcap 760 and the second endcap 770. In some arrangements, the first endcap 760 and the second endcap 770 can be configured to allow the shape memory material member 780 to turn around and extend in the opposite direction, as described above.

In some arrangements, there can be a plurality of shape memory material members 780. In such case, the plurality of shape memory material members 780 can be distributed, arranged, and/or oriented in any suitable manner. For instance, the shape memory material members 780 can extend substantially parallel to each other. In other arrangements, one or more of the shape memory material members 780 can extend non-parallel to the other shape memory material members 780. In some instances, some of the plurality of shape memory material members 780 may cross over each other.

Referring to FIGS. 4A-4B, in some arrangements, one or more second actuator(s) 120b may be mounted on the first actuator push structure 950 in a stacked configuration, for example on engaging surface 953. For example, as previously described with regard to FIGS. 3A-3B, the first actuator 120a may include a first actuator base 736 and a first actuator push structure 950 structured to be movable with respect to the first actuator base 736 during morphing of the actuator. In addition, the second actuator 120b may be mounted on first actuator push structure 950 to provide a stacked configuration of the second actuator 120b on the first actuator 120b.

FIGS. 4A-4B show an example of a second actuator 120b suitable for use according to arrangements herein. The basic details of the second actuator 120b will now be described. Additional details of the second actuator 120b are described in U.S. patent application Ser. No. 18/329,217, which is incorporated herein by reference. The second actuator 120b shown in FIGS. 4A-4B is merely one example of a suitable actuator in accordance with arrangements described herein and is not intended to be limiting. Actuators suitable for use as second actuator are described in U.S. patent Publication Ser. Nos. 17/729,522, 18/452,734, 18/453,395, 18/452,343, 18/399,026 and 18/329,217 as well as U.S. Pat. Nos. 10,960,793, which are incorporated herein by reference in their entireties. Further, it will be appreciated that arrangements described herein are not limited to actuators with contracting member(s) or shape memory material member(s).

The second actuator(s) may be mounted or connected to the first actuator so that activation of the first actuator produces a movement of the second actuator(s) in a direction toward an occupant of the seat. In some arrangements, the second actuator 120b may have the same structure as the first actuator 120a and may be a smaller or scaled-down version of the first actuator 120a. In some arrangements, the second actuator 120b may be a massaging actuator configured and mounted on the first actuator so as to create a massaging effect on a seat user when activated and brought into contact with the user.

The second actuator 120b can include a first outer body member 110, a second outer body member 130, a first endcap 160, a second endcap 170, and a contracting member 180. The first endcap 160 and the second endcap 170 can be spaced apart in a first direction 101. The first outer body member 110 and the second outer body member 130 can be spaced apart in a second direction 102.

The first outer body member 110 can include a first portion 112 and a second portion 114. The first portion 112 and the second portion 114 can be operatively connected to each other such that the first portion 112 and the second portion 114 can move relative to each other. In one or more arrangements, the first portion 112 and the second portion 114 can be pivotably connected to each other. For example, the first portion 112 and the second portion 114 can be pivotably connected to each other by one or more hinges 115. The first portion 112 and the second portion 114 can be angled relative to each other. As a result, the first outer body member 110 can have a generally V-shape.

The second outer body member 130 can include a first portion 132, a second portion 134, and a base 136. In one or more arrangements, each of the first portion 132 and the second portion 134 can be pivotably connected to the base 136. For example, the first portion 132 can be pivotably connected to the base 136 by one or more hinges 133, and the second portion 134 can be pivotably connected to the base 136 by one or more hinges 135. The first portion 132 and the second portion 134 can be located on opposite sides of the base 136.

As noted above, the second actuator 120b can include a first endcap 160 and a second endcap 170. The first endcap 160 and the second endcap 170 can have any suitable size, shape, and/or configuration. In one or more arrangements, the first endcap 160 and the second endcap 170 can be substantially identical to each other. In one or more arrangements, the first endcap 160 and the second endcap 170 can be different from each other in one or more respect.

The second actuator 120b can include one or more contracting members 180. The contracting member(s) 180 can be any structure that, when activated, is configured to shrink in length. In one or more arrangements, the contracting member(s) 180 can be one or more shape memory material members 181. The shape memory material member(s) 181 can extend between the first endcap 160 and the second endcap 170 in any suitable manner. The shape memory material member(s) 181 can be operatively connected to the first endcap 160 and the second endcap 170. Any suitable manner of operative connection can be provided, such as one or more fasteners, one or more adhesives, one or more welds, one or more brazes, one or more forms of mechanical engagement, or any combination thereof.

It should be noted that the shape memory material member(s) 181 forming the contracting member(s) 180 can be located substantially entirely within the overall envelope of the second actuator 120b. A portion of the shape memory material member(s) 181 can extend outside of a respective one of the endcaps 160, 170 for operative connection to another conductor and/or power source.

In some arrangements, there can be a single shape memory material member 181. In such case, the shape memory material member 181 can, for example, extend straight across the cavity from the first endcap 160 and the second endcap 170. In another example, the shape memory material member 181 can extend in a serpentine pattern between the first endcap 160 and the second endcap 170. In some arrangements, the first endcap 160 and the second endcap 170 can be configured to allow the shape memory material member 181 to turn around and extend in the opposite direction, as described above.

In some arrangements, there can be a plurality of shape memory material members 181. In such case, the plurality of shape memory material members 181 can be distributed, arranged, and/or oriented in any suitable manner. For instance, the shape memory material members 181 can extend substantially parallel to each other. In other arrangements, one or more of the shape memory material members 181 can extend non-parallel to the other shape memory material members 181. In some instances, some of the plurality of shape memory material members 181 may cross over each other.

The second actuator 120b can include a first dimension 190, which can correspond to the first direction 101. The second actuator 120b can include a second dimension 195, which can correspond to the second direction 102. The first dimension 190 can describe a width of the second actuator 120b, and the second dimension 195 can describe a height of the second actuator 120b. The first dimension 190 and the second dimension 195 can be substantially perpendicular to each other.

In one or more arrangements, one or more second actuator(s) 120b may be mounted to the first actuator 120a by securing second actuator base(s) 136 to first actuator platform 951 using mechanical fastener(s), an adhesive, or any other suitable method.

FIG. 4A shows an example of the second actuator 120b in a non-activated condition. Here, the shape memory material member(s) 181 are not activated. FIG. 4B shows an example of the second actuator 120b in an activated condition. When an activation input (e.g., electrical energy or other input that can change the temperature of the shape memory material member(s) 181) is provided to the shape memory material member(s) 181, the shape memory material member(s) 181 can contract. This contraction can cause the second actuator 120b to morph into the activated condition. More particularly, the contraction can cause the shape memory material member(s) 181 to pull the first endcap 160 and the second endcap 170 toward each other in the first direction 101. As a result, the first outer body member 110 and the second outer body member 130 can extend outward and away from each other in a direction that corresponds to the second direction 102. It will be appreciated that, in going from the non-activated condition to the activated condition, the first dimension 190 (i.e., the width dimension) of the second actuator 120b can decrease and/or the second dimension 195 (i.e., the height dimension) of the second actuator 120b can increase. Further, it will be appreciated that the second actuator 120b can deliver a force in a direction that is out of plane or otherwise different from the direction of contraction of the shape memory material member(s) 181.

The second actuator 120b can include a push structure 150. The push structure 150 can be configured to engage other structures, surfaces, or objects. The push structure 150 can focus the force of the second actuator 120b on an intended target object. The push structure 150 can have any suitable size, shape, and/or configuration. In one or more arrangements, the push structure 150 can be substantially T-shaped. In some arrangements, the push structure 150 can include a platform 151 and a stem 152. In some arrangements, the platform 151 can substantially be a rectangular prism, as is shown. In some instances, the platform 151 can have downturned ends 154, as shown. In some instances, the platform 151 can be a plate-like structure. In other arrangements, the platform 151 can be substantially cylindrical, substantially elliptical cylindrical, substantially triangular prismatic, substantially polygonal prismatic, substantially hexagonal prismatic, substantially octagonal prismatic, substantially trapezoidal prismatic, substantially barrel-shaped, or substantially half-barrel shaped, just to name a few possibilities.

The platform 151 can have an engaging surface 153. The engaging surface 153 can be configured to provide a desired actuation effect on an intended target. In some arrangements, the engaging surface 153 can be substantially planar. In some arrangements, the engaging surface 153 can include one or more contours, protrusions, steps, recesses, elements, or other raised or non-planar features. The engaging surface 153 can be configured to create a focal point for the push force of the second actuator 120b. In some arrangements, the engaging surface 153 can include textures to provide an additional sensation. In some arrangements, the engaging surface 153 can include at least partially embedded rollers or other features to provide an additional sensation.

The engaging surface 153 can have any suitable size, shape, and/or configuration. For instance, the engaging surface 153 can be substantially rectangular, substantially circular, substantially oval, substantially polygonal, substantially triangular, substantially hexagonal, substantially octagonal, or substantially trapezoidal, just to name a few possibilities. In some arrangements, the engaging surface 153 can be substantially parallel to the shape memory material member(s) 181 and/or to the first direction 101 of the second actuator 120b. In some arrangements, the engaging surface 153 can be angled relative to the shape memory material member(s) 181/contracting member(s) 180 and/or to the first direction 101 of the second actuator 120b. The engaging surface 153 can have any suitable orientation to achieve a desired actuation force effect.

The push structure 150 can be operatively connected to the first outer body member 110. In some arrangements, the push structure 150 can be operatively connected to the first portion 112 and the second portion 114. While the first portion 112 and the second portion 114 can pivot relative to each other, the push structure 150 can substantially maintain its orientation. In some arrangements, the push structure 150 can be substantially centrally located on the first outer body member 110. However, in other arrangements, the push structure 150 can be offset from the center of the first outer body member 110. In some arrangements, the second actuator 120b can be a plurality of push structures 150.

When the second actuator 120b morphs into the activated condition, the position of the push structure 150 can change. For instance, in the orientation of the second actuator 120b shown in FIGS. 4A-4B, the push structure 150 moves to a higher elevation when the second actuator 120b morphs from the non-activated condition to the activated condition.

One or more massaging elements 155 can be operatively connected to the push structure 150 such that the one or more massaging elements 155 are movable thereon. In one or more arrangements, the one or more massaging elements 155 can be operatively connected to the platform 151. The one or more massaging elements 155 can be configured such that, when the one or more massaging elements 155 come into contact with a surface or object, the one or more massaging elements 155 can move. The massaging elements 155 may be structured and operable as described in U.S. patent application Ser. No. 18/452,376 (incorporated herein by reference in its entirety) to be movable to generate a massaging effect.

There can be any suitable number of massaging elements 155 on the push structure. For instance, in one or more arrangements, there can be a single massaging element 155 operatively connected to the push structure 150. In such case, the single massaging element 155 can be provided in any suitable location on the push structure 150. For instance, the single massaging element 155 can be substantially centrally located on the push structure 150. Alternatively, the single massaging element 155 can be located at or near one of the sides, edges, or corners of the push structure 150. In some instances, the single massaging element 155 can be substantially the same size as the engaging surface 153 of the push structure 150.

In some instances, there can be a plurality of massaging elements 155 operatively connected to the push structure 150. In some instances, the plurality of massaging elements 155 can be substantially identical to each other. Alternatively, one or more of the plurality of massaging elements 155 can be different from the other massaging elements 155 in one or more respects, such as size, shape, configuration, movement, massaging effect, etc.

In such cases, the plurality of massaging elements 155 can be distributed on the push structure 150 in any suitable manner. For instance, the plurality of massaging elements 155 can be located adjacent to each other. Alternatively, the plurality of massaging elements 155 can be spaced apart. In some arrangements, the plurality of massaging elements 155 can be located on opposite sides of the push structure, as is shown as a non-limiting example in FIGS. 4A and 4B. In other arrangements, the plurality of massaging elements 155 can be distributed near the sides or edges of the push structure 150 so as to extend substantially about the perimeter of the engaging surface 153. In other arrangements, the plurality of massaging elements 155 can be located along one or more sides of the engaging surface 153. In some arrangements, the plurality of massaging elements 155 can be centrally located on the push structure 150.

In some instances, at least some of the plurality of massaging elements 155 can be arranged in alignment with each other. For instance, a plurality of the massaging elements 155 can be arranged in rows and/or columns on the push structure 150. In some instances, the plurality of massaging elements 155 can be arranged in a plurality of discrete areas, which may or may not be spaced apart, on the push structure 150. In some arrangements, the plurality of massaging elements 155 can be distributed so as to substantially cover a portion of, a majority of, or the entirety of the engaging surface 153 of the push structure 150.

In some arrangements, the plurality of massaging elements 155 can be arranged so as to be substantially aligned with each other, as is shown in FIGS. 4A and 4B. However, in other arrangements, one or more of the plurality of massaging elements 155 can be offset from the other massaging elements 155 in one or more directions. In some instances, the massaging elements 155 can be raised from the engaging surface 153 at different lengths.

As used herein, the term “lumbar support system” refers to a system configured to adjustably support a lumbar region of a human user. Each arrangement of the lumbar support system described herein is structured to provide at least some degree of lumbar support when incorporated into the seat. In addition, the levels of lumbar support provided by any particular arrangement may be varied by activating and deactivating the actuator(s) incorporated into the particular arrangement. A lumbar support system is considered to be “activated” and in an “activated condition” when at least one actuator of the lumbar support system is activated. Generally, when any particular arrangement of the lumbar support system is activated, the arrangement will provide a greater degree of lumbar support to the seated user than a non-activated condition of the arrangement. For example, the activated condition of the second actuator 120b shown in FIG. 4B provides a greater degree of lumbar support to the seated user than the non-activated condition shown in FIG. 4A.

In some arrangements, to provide a substantially continuous level of lumbar support, to the seat occupant, the control module(s) 280 can be configured to maintain an activated condition of the actuator 120 as previously described. In other arrangements, a different method and/or mechanism may be used to maintain the activated condition of the actuator 120. For example, in certain arrangements, a mechanical or electromechanical locking mechanism 99 may be incorporated into one or more of the hinged connections of the first actuator 120a. In one or more arrangements, the locking mechanism 99 is in the form of a toothed interlock clutch (such as a known or later developed electromagnetic tooth clutch) which may be incorporated into one or more of the hinged connections of the first actuator 120a. A toothed interlock clutch, also known as a tooth clutch or jaw clutch, is a system that transfers torque through the engagement of interlocking teeth. Such a system is often used in applications where space is limited, such as medical and printing machinery. Complementary engageable teeth are provided on a rotor and armature of the clutch. Each of the rotor and armature is connected to a respective first portion and second portion of the first actuator structure, where the first portion and second portion of the first actuator are pivotably connected. When the first actuator 120a is in the activated condition, a DC voltage is applied to an electromagnet mounted on the rotor to generate a magnetic field that pulls the armature across an air gap toward the rotor, causing the complementary teeth to engage. This engagement rotationally locks the pivotably connected first and second portions of the first actuator with respect to each other. This prevents the first actuator from reverting to the non-activated condition as long as the DC voltage is applied. After the pivotable connection(s) of the first actuation are locked by associated clutch(es), the first actuator(s) 120a is maintained in the activated condition by the energized clutch, and the electrical current energizing the shape memory material member 780 may be discontinued. One source of suitable electromagnetic tooth clutches is KEB AMERICA, Inc. or Shakopee, MN (available at https://www.kebamerica.com/).

When it is desired to revert the first actuator 120a to its non-activated condition, the shape memory material member 780 may be energized to the level previously used to bring the first actuator 120a to its activated condition. Then, the DC voltage applied to the clutch rotor may be removed, thereby unlocking the first actuator 120a. Then, the current energizing the shape memory material member 780 may be removed (i.e., the shape memory material member 780 may be de-energized), thereby allowing the first actuator 120a to return to the non-activated condition. any of a variety of suitable alternative mechanical or electro-mechanical locking mechanisms may be used, employing elements such as, for example, clutches, solenoids, gears, etc.

Although the locking mechanism 99 is described above as it may be applied to the first actuator 120a, it will be understood that a similar or different locking mechanism may also be applied any second actuator 120b (including a second actuator mounted on an associated first actuator) and/or on any additional actuator.

Now that the various potential systems, devices, elements and/or components of the system 200 have been described, various methods and operations will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

Generally, in one or more arrangements described herein, a lumbar support structure may include a first lumbar support and a second lumbar support. At least one of the first and second lumbar supports may include at least one actuator having one or more shape memory material members. The at least one actuator may be structured and operatively connected to the other one of the first and second lumbar supports so that an activation input provided to the one or more shape memory material members causes the one or more shape memory material members to contract, thereby causing a distance between a portion of the actuator and the other one of the first and second lumbar supports to increase.

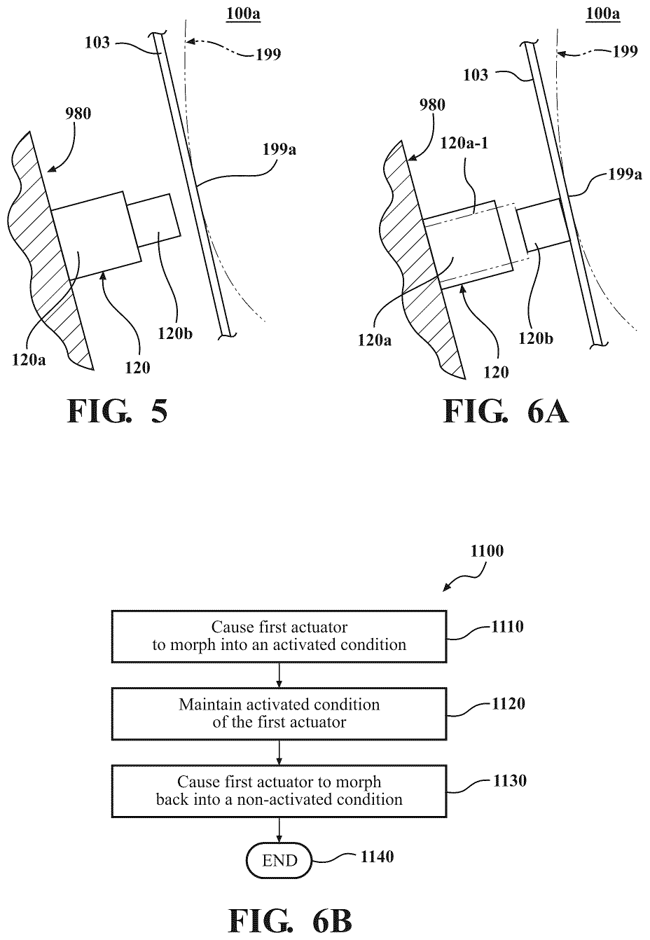

In particular arrangements, the first lumbar support includes at least one first actuator in accordance with an arrangement described herein and the second lumbar support includes at least one second actuator in accordance with an arrangement described herein. FIG. 5 is a schematic side cross-sectional view of a portion of a seat back arrangement 100a showing an exemplary lumbar support structure in the form of a composite or dual actuator 120 formed from two separate actuators in accordance with an arrangement described herein. In one or more arrangements, the lumbar support structure/actuator 120 may include a first actuator 120a and one or more second actuator(s) 120b. For purposes of illustration, the actuator 120 in FIG. 5 includes a single second actuator 120b mounted on a first actuator 120a in a stacked configuration. However, as stated elsewhere herein, multiple second actuators 120b may be mounted on a single first actuator 120a in a manner described herein. The actuator 120 in FIG. 5 is shown with both the first actuator 120a and the second actuator 120b in respective non-activated conditions. The actuator 120 is shown mounted inside a seat behind a cover 103 of the seat 100. A lumbar region 199a of a seat occupant 199 is shown resting against the seat cover 103 opposite the actuator 120.

In addition, each of the first actuator and the second actuator may have one or more shape memory material members. Also, each actuator may be structured and operatively connected to the other actuator so that an activation input provided to the one or more shape memory material members of one actuator causes the one or more shape memory material members of the one actuator to contract, thereby causing a distance between a portion of the one actuator and the other actuator to increase. For example, FIG. 6A is the schematic view of FIG. 5 showing the first actuator 120a in an activated condition 120a-1 (shown in phantom) and the second actuator 120b in the non-activated condition of FIG. 5. In this actuation scenario, the activated first actuator 120a may push the second actuator 120b toward (and into indirect contact with) a user 199 through the intervening seat cover 103. For example, the second actuator 120b may exert pressure on the lumbar area 199a of the user 199 by pressing against the seat cover 103.

Turning to FIG. 6B, an example of a method 1100 of seat actuation relating to FIG. 6A is shown. As described previously, the first actuator 120a can be operatively positioned relative to a lumbar region of a seat 100. One or more processors 210 can be operatively connected to the first actuator 120a. While the method 1100 will be described in connection with a single first actuator 120a, it will be appreciated that the method 1100 may be applied to arrangements in which there are a plurality of first actuators 120a.

At block 1110, the actuator 120 can be caused to morph into an activated condition to support a lumbar region of a seat occupant. Such causing can be performed by the processor(s) 210 and/or the control module(s) 280. For instance, the processor(s) 210 and/or the control module(s) 280 can cause electrical energy from the power source(s) 240 (or energy from any other suitable source) to be supplied to the actuator 120. More particularly, the processor(s) 210 and/or the control module(s) 280 can cause electrical energy from the power source(s) 240 (or energy from any other suitable source) to be supplied to contracting member(s) s (e.g., shape memory material member(s), shape memory alloy wire(s), etc.) of the first actuator 120a. When the first actuator 120a morphs into an associated activated condition 120a-1, a dimension (e.g., the height) of the first actuator 120a can increase. The causing can be performed automatically, in response to a user input (e.g., provided on the input interface(s) 250), or in any other suitable way. As seen in FIG. 6A, the increase in the dimension of the first actuator 120a can cause the one or more second actuators 120b connected to the first actuator 120a to come into indirect contact with the seat occupant 199 through the seat cover 103, thereby providing a supporting force on the lumbar region 199a of the seat occupant 199. The lumbar contact by the collective one or more second actuators 120b supported by associated activated first actuator(s) 120a may provide lumbar support over the area of contact.

At block 1120, the activated condition of the first actuator 120a can be maintained. Thus, a substantially continuous level of lumbar support can be provided to the seat occupant. The maintaining of the activated condition can be performed by the processor(s) 210 and/or the control module(s) 280. The maintaining can include adjusting the activated condition of the first actuator 120a. Such adjusting can be performed in real-time based on data acquired by the sensor(s) 230 and/or the sensor(s) 125. The maintaining can include adjusting the activated condition of the first actuator 120a so as to maintain the substantially continuous level of lumbar support. Adjusting the activated condition can include increasing or decreasing the actuated position or force output of the first actuator 120a (or one or more individual first actuator 120a when there is a plurality of first actuators 120a). The increasing or decreasing the actuated position or force output can be performed by adjusting the supply of electrical energy from the power source(s) 240 (or energy from any other suitable source) to the first actuator 120a. In some arrangements, the activated condition can be maintained by keeping the supply of electrical energy (or other form of energy) to the first actuator 120a substantially constant.

In block 1130, when the substantially continuous level of lumbar support is no longer desired, the first actuator 120a may be caused to morph back into a non-activated condition as shown in FIG. 5, to move the one or more second actuators 120b out of contact with the seat occupant, thereby removing the lumbar support. For example, the first actuator 120a may be caused to morph back into a non-activated condition by de-energizing the one or more shape memory material member(s) 780 or by releasing a locking mechanism maintaining the actuator in the activated condition.

The method 1100 can end (block 1140). Alternatively, the method 1100 can return to block 1110 or to some other block. The method 1100 can be repeated at any suitable point, such as at a suitable time or upon the occurrence of any suitable event or condition.

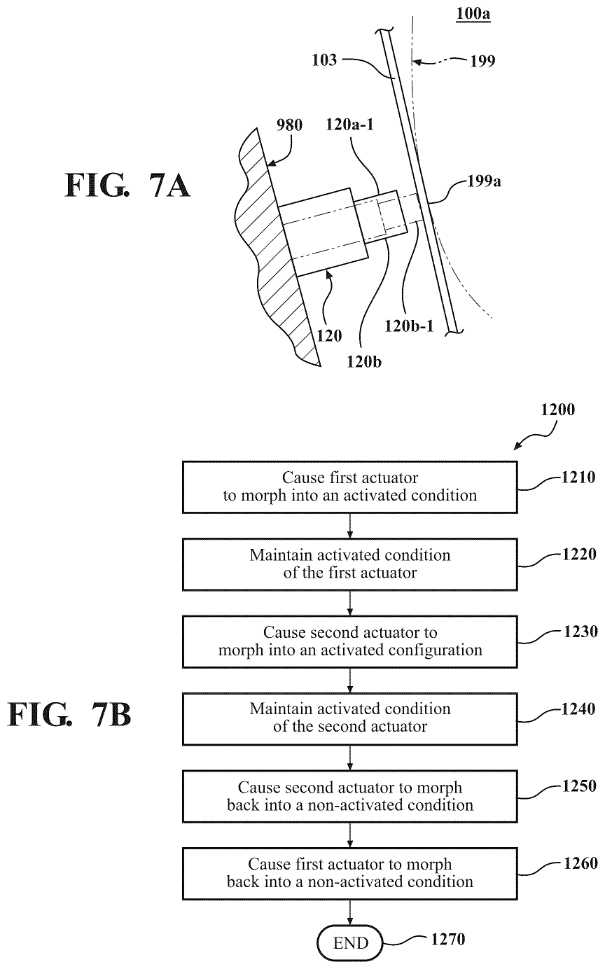

FIG. 7A is the schematic view of FIG. 5 showing the first actuator 120a in an activated condition and the second actuator 120b in an activated condition. In this actuation scenario, in some arrangements, both first actuator 120a and the second actuator 120b may be maintained or “locked” in respective static activated conditions after activation to provide an enhanced lumbar support effect. Turning to FIG. 7B, an example of a method 1200 of seat actuation relating to FIG. 7A is shown. As described previously, the first actuator 120a can be operatively positioned relative to a lumbar region of a seat 100. One or more processors 210 can be operatively connected to the first actuator 120a. While the method 1200 will be described in connection with a single first actuator 120a, it will be appreciated that the method 1200 applied to arrangements in which there are a plurality of first actuators 120a.

At block 1210, the actuator 120 can be caused to morph into an activated condition to support a lumbar region of a seat occupant, by energizing the first actuator 120a as previously described with regard to FIGS. 6A-6B. At block 1220, the activated condition of the first actuator 120a can be maintained in the manner previously described with regard to FIGS. 6A-6B. At block 1230, the processor(s) 210 and/or the control module(s) 280 can cause electrical energy from the power source(s) 240 (or energy from any other suitable source) to be supplied to contracting member(s) s (e.g., shape memory material member(s), shape memory alloy wire(s), etc.) of the second actuator 120b. When the second actuator 120b morphs into an associated activated condition 120b-1 (shown in phantom), a dimension (e.g., the height dimension 195) of the second actuator 120b can increase. The causing can be performed automatically, in response to a user input (e.g., provided on the input interface(s) 250), or in any other suitable way. The increase in the dimension of the second actuator(s) 120b can cause the one or more second actuators 120b connected to the first actuator 120a to come into indirect contact with the seat occupant through the seat cover 103, thereby providing a supporting force on the lumbar region of the seat occupant. The lumbar contact by the collective one or more second actuators 120b supported by associated activated first actuator(s) 120a may provide lumbar support over the area of contact.

At block 1240, the activated condition of the second actuator 120b can be maintained in a manner described herein. Thus, an enhanced and substantially continuous level of lumbar support can be provided to the seat occupant. In block 1250, when the substantially continuous level of lumbar support is no longer desired, the second actuator 120b may be caused to morph back into a non-activated condition as shown in FIG. 5, to move the one or more second actuator 120b out of contact with the seat occupant, thereby removing the lumbar support. For example, the second actuator 120b may be caused to morph back into a non-activated condition by de-energizing the one or more shape memory material member(s) 181.

In block 1260, when the substantially continuous level of lumbar support is no longer desired, the first actuator 120a may be caused to morph back into a non-activated condition as shown in FIG. 5, to further move the second actuator 120b out of contact with the seat occupant, thereby removing the lumbar support. For example, the first actuator 120a may be caused to morph back into a non-activated condition by de-energizing the one or more shape memory material member(s) 780.

The method 1200 can end (block 1270). Alternatively, the method 1200 can return to block 1210 or to some other block. The method 1200 can be repeated at any suitable point, such as at a suitable time or upon the occurrence of any suitable event or condition.

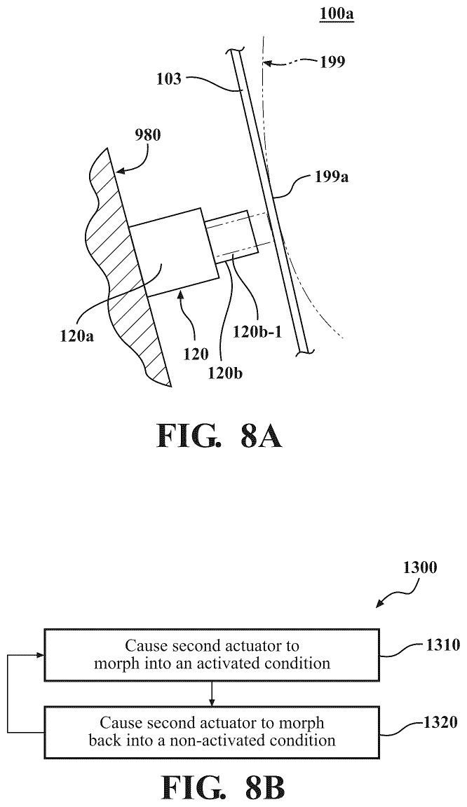

FIG. 8A is the schematic view of FIG. 5 showing the first actuator 120a in a non-activated condition and the second actuator 120b in an activated condition. In this actuation scenario, the second actuator 120b may be “cycled” to provide a massaging effect by intermittent energization and de-energization of the contracting member(s) 180. In particular arrangements, referring again to FIGS. 4A-4B, the second actuator may include a second actuator base 136, a second actuator push structure 150 structured to be movable with respect to the second actuator base 136 during morphing of the actuator 120b, and one or more massaging elements 155 extending from the second actuator push structure 150.

FIG. 8B shows an example of a method 1300 of seat actuation relating to FIG. 8A. At block 1310 one or more second actuator(s) 120b may be caused to morph into an activated condition as previously described, thereby moving the massaging elements 155 toward and into indirect contact with a seat occupant to produce a massaging effect. At 1320 the one or more second actuator(s) 120b may be caused to morph back into a non-activated condition as shown in FIG. 5, thereby moving the massaging elements 155 away from and out of indirect contact with a seat occupant to produce a massaging effect. If a repeated or periodic massaging effect is desired, the method may repeatedly cycle between blocks 1310 and 1320, where the process just described is repeated until the repeated or periodic massaging effect is no longer desired, at which time the method may end.

The cycle time of the massaging effect may be defined by the total time required by the shape memory material members to contract and expand, thereby completing a full cycle. The cycle time is the sum of heating time (i.e. contraction time) and cooling time (i.e. expansion time). The heating time of the shape memory material members can be reduced by increasing the magnitude of actuation current. The cooling rate of the shape memory material members is limited by the rate of heat transfer to the environment surrounding the shape memory material members. The heating and cooling time also depends on the size and shape of the shape memory material members. Shape memory material members with relatively smaller diameters cool faster compared with those having relatively larger diameters. However, reducing the diameter of a shape memory material member will affect the loading capacity of the member.

It is also noted that, with regard to the scenario previously described with respect to FIGS. 7A-7B, instead of locking the first actuator into a static state, the first actuator 120a may be “cycled” between activated and non-activated states by intermittent energization and de-energization of the contracting member(s) 780 to provide a reciprocating or massaging effect, as just described with respect to FIGS. 8A-8B.

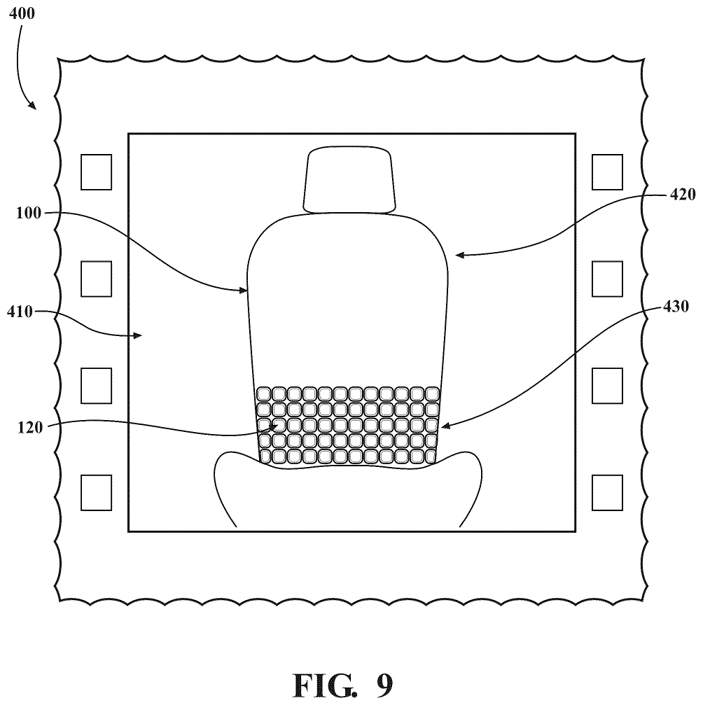

FIG. 9 shows an example of one method of controlling operation of the actuators 120. FIG. 9 shows an example in which a user interface is presented on a display 400. The display can be a part of the output interface(s) 255 and/or the input interface(s) 250 of the system 200. In one or more arrangements, the display 400 can be part of a vehicle infotainment system or head unit of a vehicle. In some arrangements, the display 400 can be a portion of another vehicle system, such as a navigation system, a vehicle radio or audio system, a backup camera display, and/or other vehicle monitor. In one or more arrangements, the display 400 can be located in a front interior portion of the vehicle. For instance, the display 400 can be included in a dashboard or instrument panel of the vehicle. Of course, it will be appreciated that arrangements described herein can be customized using other user interfaces, such as on a portable communication device (e.g., a cellular telephone, a smart phone, etc.), a voice interface, a gesture interface, a computer (e.g., a laptop, a tablet, a phablet, etc.), etc.

The display 400 can be any suitable type of display, now known or later developed. In one or more arrangements, the display 400 can be a touch screen display, which can allow a user to engage or interact with one or more displayed elements, such as a graphical user interface (GUI) 410, and/or other applications running on any vehicle system, including any of those described herein, through contact with the forward display. For example, a user may make selections and/or move a cursor by simply touching the display 400 via a finger or stylus.

In the example shown in FIG. 9, the GUI 410 can present a representation of at least a portion of the seat 420. A representation of one or more actuators 430 can be presented on the representation of the seat 420. The representation of the one or more actuators 430 can correspond to the location of the actuator(s) (e.g., actuator(s) 120) associated with the seat (e.g., seat 100) of the vehicle. The GUI 410 can be presented automatically whenever the actuators are in use, when requested by a user, or upon some other condition or event.

In some arrangements, the GUI 410 can be configured to present a currently in use activation profile. The GUI 410 can show which of the actuator(s) are activated, such as by highlighting them. The GUI 410 can be updated in real time to show changes in the actuator(s). Additional or alternative effects can be used to represent a status or condition of the actuator(s). In some arrangements, the GUI 410 can allow a user to define a new activation profile and/or modify an existing activation profile. The GUI 410 can allow a user to select all of the actuator(s), individual actuator(s), a plurality of actuators, one or more rows of actuators, one or more columns of actuators, one or more regions of actuators, any other subset of the actuators, or any combination thereof. When a selection of one or more actuators is made, a user can assign one or more settings, conditions, parameters, or attributes for the selected actuators. The settings can include activation time, activation duration, activation patterns (e.g., pulses), activation strength, activation speed, activation degree, activation sequence, other activation settings, and any combination thereof. The user inputs can be saved as one or more associated actuation profile(s).

In some instances, the GUI 410 can present a suggested activation profile to a user. The user can try the actuation profile, decline the activation profile, or modify the actuation profile. The actuation profile can be saved to the data store(s) 220 and/or to the data store 220. In this example, the actuators 120 are shown in a portion of the seat corresponding to the lumbar region 113 of the seat. However, it will be appreciated that the arrangements described herein are not limited in this regard. Indeed, the GUI 410 can represent actuators in other areas of the representation of the seat, such as in other portions of the back, the headrest, seat portion, bolter(s), arm rest(s), or any other portion of the seat. The GUI 410 can allow a user to select other areas of the seat. It will be appreciated that an actuation profile can cover one or more areas of the seat. For instance, a user can create an actuation profile that includes constant activation in the lumbar region while simultaneously providing a massaging effect in other areas of the user's body.

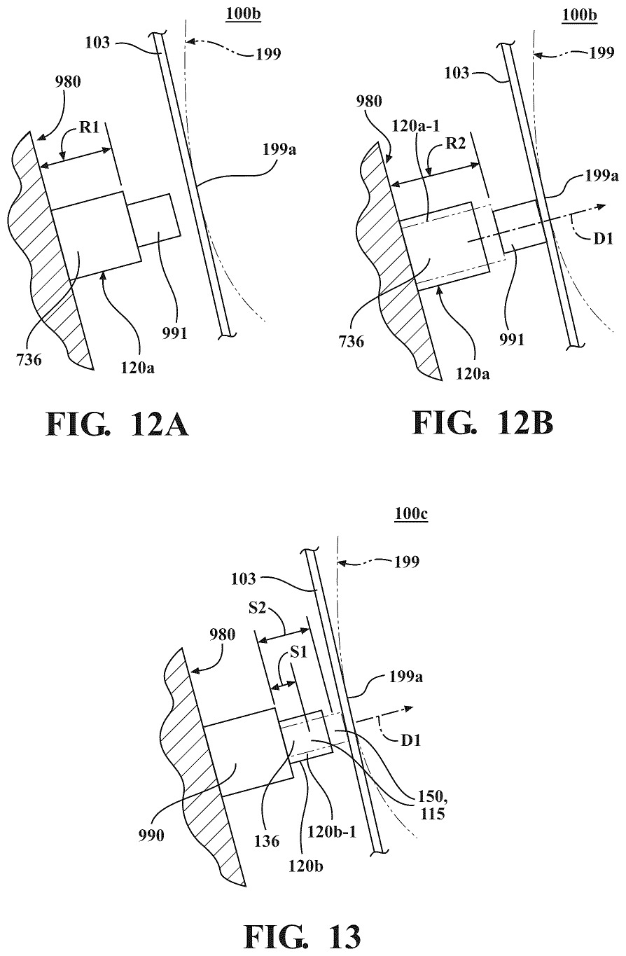

In one or more other arrangements of the lumbar support structure, the first lumbar support comprises at least one actuator and the second lumbar support comprises a resiliently deformable lumbar support element. “Resiliently deformable” means that the element is deformable (e.g., compressible) responsive to application of a force thereto, to absorb the applied force, and also that the element is structured to return to its undeformed condition after removal of the applied force. In one or more arrangements described herein, the resiliently deformable lumbar support element may be in the form of a cushion structured for lumbar support. Other, alternative forms of resiliently deformable lumbar support elements may also be used. For example, referring to FIGS. 4A, 4B, 12A and 12B, in one example, the first lumbar support of the seat back arrangement 100b may be at least one actuator 120a as previously described and the second lumbar support may be one or more resiliently deformable lumbar support element(s) 991. The one or more resiliently deformable lumbar support element(s) described herein may be structured to provide lumbar support to a user when exerting a physical force (either directly or indirectly) on the lumbar region of the user. The one or more resiliently deformable lumbar support element(s) 991 may be mounted on the least one actuator 120a so as to be positioned between the at least one actuator 120a and the lumbar region 199a of the occupant 199 when the at least one actuator 120a and the one or more resiliently deformable lumbar support element(s) 991 are positioned in a lumbar portion of a seat and the occupant is seated in the seat. The base 736 of the actuator 120a may be secured to a seat base structure (generally designated 980) inside the seat back. In some arrangements, the seat base structure 980 may be in the form of a static, rigid portion of a frame of the seat back. In some arrangements, the seat base structure 980 may be in the form of a known other adjustable lumbar support mounted within the seat back interior (e.g., such as a Schukra adjustable lumbar support, available from Schukra of North America Ltd. of Tecumseh, Ontario, Canada)). The Schukra lumbar support is itself independently adjustable by a user to vary the degree of lumbar support. For example, in the arrangement shown in FIGS. 12A and 12B, to maximize a controllable degree of lumbar support, the Schukra lumbar support (or other adjustable lumbar support) may be activated to move the entire actuator 120a and resiliently deformable lumbar support element(s) 991 in a direction D1 toward a lumbar region 199a of a seated user 199. In addition, referring to FIG. 12B, an activation input provided to the one or more shape memory material members 180 of actuator 120a may cause the actuator to extend in direction D1 to an activated condition 120a-1 (shown in phantom) as previously described herein, thereby increasing a distance between the resiliently deformable lumbar support element(s) 991 and the actuator base 736, from R1 to R2.

Because the Schukra device and the lumbar support structure of the instant application are independently adjustable to vary the degree of lumbar support, mounting of a lumbar support structure arrangement as described herein on a Schukra lumbar support (or another adjustable lumbar support) incorporated into the seat back may provide additional flexibility (independent of the lumbar support structure arrangements described herein) in adjusting the lumbar support provided to the user.

In one or more other arrangements of the lumbar support structure, the first lumbar support includes at least one resiliently deformable lumbar support element, and the second lumbar support comprises at least one actuator in accordance with an arrangement described herein. For example, referring to FIGS. 4A-4B and 13, the first lumbar support of a seat back arrangement 100c may be a resiliently deformable lumbar support element(s) 990 structured for lumbar support as previously described, the second lumbar support may be at least one actuator 120b as previously described,

The one or more actuator(s) 120b may be mounted on the least one resiliently deformable lumbar support element(s) 990 so as to be positioned between the at least one resiliently deformable lumbar support element(s) 990 and the lumbar region 199a of the occupant 199 when the at least one actuator 120b and the least one resiliently deformable lumbar support element(s) 990 are positioned in a lumbar portion of a seat and the occupant is seated in the seat. The base 136 of the actuator 120b may be secured to a seat base structure 980 as previously described inside the seat back. In some arrangements, the seat base structure 980 may be in the form of a static, rigid portion of a frame of the seat back. In some arrangements, the seat base structure 980 may be in the form of a known other adjustable lumbar support (such as a Schukra adjustable lumbar support) as previously described mounted within the seat back interior. In the arrangement shown in FIG. 13, to maximize a controllable degree of lumbar support, the Schukra lumbar support (or other adjustable lumbar support) may be activated to move the entire actuator 120b and resiliently deformable lumbar support element(s) 991 in direction D1 toward a lumbar region 199a of a seated user 199. In addition, referring to FIG. 4B, an activation input provided to the one or more shape memory material members 180 of actuator 120b may cause the actuator to extend in direction D1 to an activated condition 120b-1 (shown in phantom) as previously described herein, thereby increasing a distance between the resiliently deformable lumbar support element(s) 991 and the actuator base 136, from S1 to S2.

Referring to FIGS. 4B and 13, in some arrangements, the portion of the actuator 120b referenced for the distance measurements S1 and S2 from portions of the actuator 120b to the resiliently deformable lumbar support element(s) 990 may be a push structure (such as push structure 150) or a hinge (such as hinge 115) of the actuator 120b residing opposite a base (such as base 136) of the actuator. An activation input provided to the one or more shape memory material members 180 may cause the actuator 120b to extend in direction D1 with respect to the actuator as described herein, thereby increasing a distance between the resiliently deformable lumbar support element(s) 990 and the hinge 115/push structure 150 from S1 to S2. Other portions of the actuator 120b may be referenced for determination of the increase in distance S as long as the activation input causes the actuator 120b to extend to the activated condition 120b-1 and the distance between the referenced portion of the actuator and the resiliently deformable lumbar support element(s) 990 to increase.

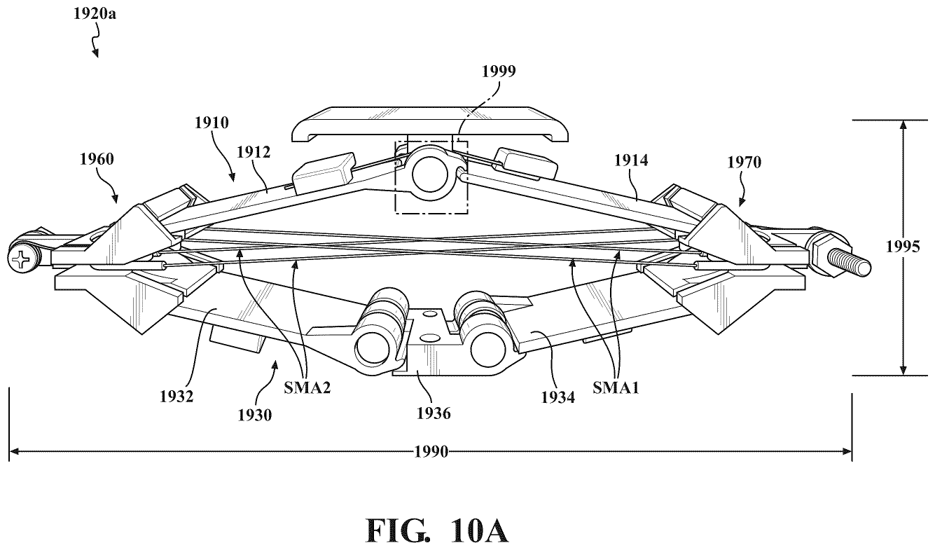

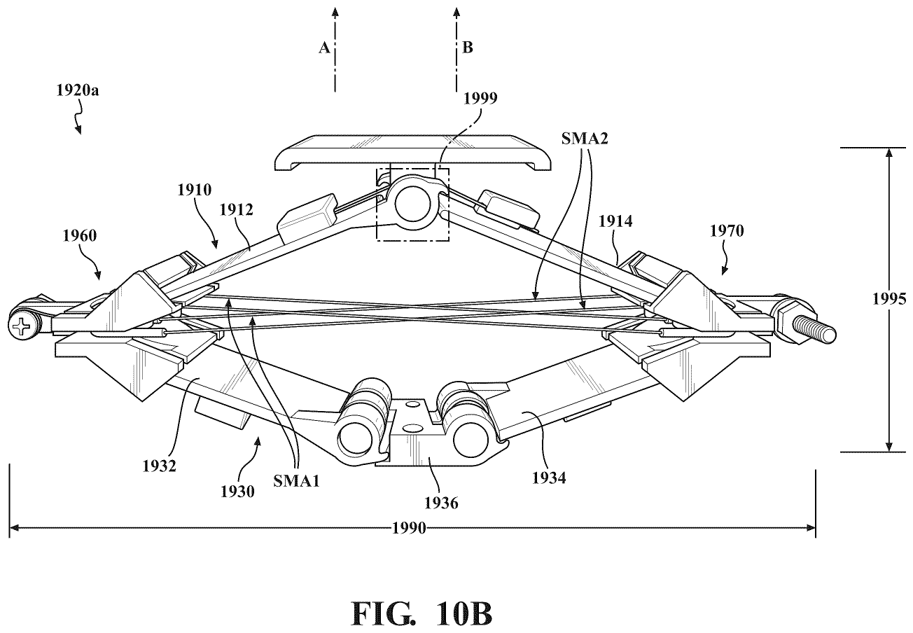

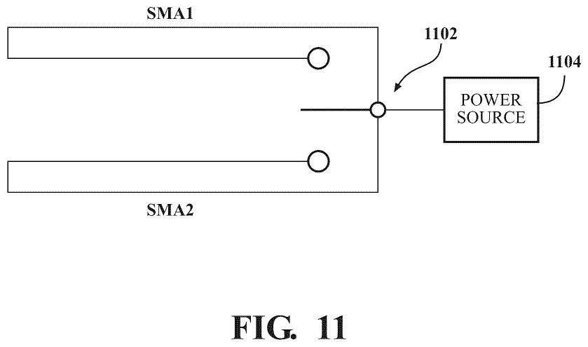

Referring now to FIGS. 10A-11, in some further arrangements, an actuator 120 includes at least a first shape memory material member and a second shape memory material member electrically isolated from, and activatable independently of, the first shape memory material member. In particular arrangements, the first shape memory material member is structured to as to generate a first push force when activated, and the second shape memory material member is structured to as to generate a second push force when activated, with the second push force being different from the first push force.

For example, rather than utilizing a single wire as a shape memory material member(s), multiple wires having different diameters, compositions, response characteristics, etc. may be incorporated into a single actuator to enable the generation of different push (or output) forces depending on which wire is energized. More specifically, FIGS. 10A and 10B are schematic views of an actuator 1920a similarly structured and operable to first actuator 120a previously described. FIG. 10A shows the actuator 1920a in a non-activated condition, and FIG. 10B shows the actuator 1920a in an activated condition. In the arrangement shown, two or more shape memory material members SMA1 and SMA2 run substantially parallel to each other yet are electrically isolated from each other.

For example, in one or more arrangements, in an actuator as shown in FIGS. 10A and 10B, the shape memory material member SMA1 can extend between the first endcap 1960 and the second endcap 1970 in any suitable manner. The shape memory material member SMA1 may be operatively connected at a first end thereof to the first endcap 1960, extended to the second endcap 1970, wound around a portion of the actuator operatively connected to the second endcap 1970, then fed back to the first endcap 1960 for operative connection of the second end of the shape memory material member SMA1 to the first endcap 1960. Similarly, the shape memory material member SMA2 can extend between the first endcap 1960 and the second endcap 1970 in any suitable manner. The shape memory material member SMA2 may be operatively connected at a first end thereof to the second endcap 1970, extended to the first endcap 1960, wound around a portion of the actuator operatively connected to the first endcap 1960, then fed back to the second endcap 1970 for operative connection of the second end of the shape memory material member SMA2 to the second endcap 1960.

In the example shown in FIGS. 10A and 10B, there are two shape memory material members SMA1 and SMA2. Activation of only the first shape memory material member SMA1 can cause the actuator 1920a to change to an associated first activated condition, generating a first push force of “A” during the change process. Activation of only the second shape memory material member SMA2 can cause the actuator 1920a to change to an associated second activated condition, generating a second push force of “B” during the change process. In some instances, only the first shape memory material member can be activated to provide a push force of A. In other instances, only the second shape memory material member can be activated to provide a push force of B. In still other instances, both the first and second shape memory material members can be activated simultaneously to provide a push force of A+B, with each shape memory material member contributing an associated component of the push force.

Contraction of the shape memory material members and the push force generated by activation of each shape memory material member for a given actuator structure may be tailored in a desired manner by appropriate specification of the wire composition, total wire length, wire diameter, the manner in which the wires are arranged and wound through the structure of the actuator and other pertinent parameters. For example, in some arrangements, the shape memory material members SMA1 and SMA2 can be the same gauge wire. In other arrangements, the shape memory material members SMA1 and SMA2 can be different gauge wires.

Of course, it will be appreciated that there can be more than two shape memory material members. For example, an actuator may incorporate a first shape memory material member, a second shape memory material member, and a third shape memory material member, with each shape memory material member being electrically isolated from the other shape memory material members and each shape memory material member extending between first and second endcaps of the actuator as described above. Activation of each individual shape memory material member may cause the actuator to change to an associated activated condition of FIG. 10B with an associated height dimension 1995, generating an associated push force during the change process. That is, activation of the first shape memory material member individually may produce an associated push force of “A” and an associated first height dimension of the actuator, activation of the second shape memory material member individually may produce an associated push force of “B” and an associated second height dimension of the actuator, and activation of the third shape memory material member individually may produce an associated push force of “C” and an associated second height dimension of the actuator.

In still other instances, two or more of the first, second and third shape memory material members can be activated in any combination to provide associated push or output forces of A+B, A+C, B+C and A+B+C. The output forces produced in the actuator by individual energization of the wires A, B, and C (individually and in various combinations) may or may not be the same.

The arrangement of shape memory material members just described with regard to FIGS. 10A-10B may be used in any of the actuators described and/or referenced herein that utilize shape memory material members for actuation.

Referring now to FIG. 11, there is a thermal lag in the shape memory material members when heating/cooling. It can take a few seconds for the shape memory material members to cool sufficiently to go below their respective phase transition temperature(s) or heat up sufficiently to reach and exceed the phase transition temperature(s). This aspect can be leveraged such that only a single power source 1104 need be operatively connectable to the plurality of shape memory material members SMA1 and SMA2. An electrical switch 1102 can be operatively connected between the single source 1104 and the plurality of shape memory material members SMA1 and SMA2. Thus, the supply of energy from the power source 1104 can be cycled between the plurality of shape memory material members SMA1 and SMA2 to maintain each of the shape memory material members above the respective phase transition temperature of each member.

In one or more arrangements, control of power cycling between the shape memory material members SMA1 and SMA2 may be performed automatically, by switching to direct power to each shape memory material member alternately in time to prevent the temperature of the member from falling below the phase transition temperature of the member. Automated switching of power between the shape memory material members may be controlled by one of control modules 280.

It is noted that the switching described above may be performed between any two shape memory material members, whether the members are incorporated into a single actuator or incorporated into separate actuators. Also, in some arrangements, switching may be performed between more than two shape memory material members.

It will be appreciated that arrangements described herein can provide numerous benefits, including one or more of the benefits mentioned herein. For example, arrangements described herein can provide support to the lumbar region of a seat occupant's back. Arrangements described here can provide a different actuation effect (e.g., massaging) to other areas of a seat occupant's body simultaneously with providing lumbar support. Arrangements described herein can provide an enhanced haptic effect. Arrangements described here can provide sensor feedback loops to monitor the performance of the actuators and the seat. Arrangements described herein can enable a high degree of customization and/or programmability to a user.

The flowcharts and block diagrams in the figures illustrate the architecture, functionality, and operation of possible implementations of systems, methods and computer program products according to various arrangements. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). As used herein, the term “substantially” or “about” includes exactly the term it modifies and slight variations therefrom.

Aspects herein can be embodied in other forms without departing from the spirit or essential attributes thereof. Accordingly, reference should be made to the following claims, rather than to the foregoing specification, as indicating the scope hereof.

What is claimed is:

1. A lumbar support structure comprising:
a first lumbar support; and
a second lumbar support,
at least one of the first and second lumbar supports including at least one actuator having one or more shape memory material members,
the at least one actuator being structured and operatively connected to the other one of the first and second lumbar supports so that an activation input provided to the one or more shape memory material members causes the one or more shape memory material members to contract, thereby causing a distance between a portion of the actuator and the other one of the first and second lumbar supports to increase.

2. The lumbar support structure of claim 1, wherein the first lumbar support comprises a resiliently deformable lumbar support element(s), and the second lumbar support comprises the at least one actuator.

3. The lumbar support structure of claim 1, wherein the first lumbar support comprises the at least one actuator and the second lumbar support comprises a resiliently deformable lumbar support element(s).

4. The lumbar support structure of claim 1, wherein the first lumbar support comprises at least one first actuator and the second lumbar support comprises at least one second actuator.

5. The lumbar support structure of claim 4, wherein each of the at least one first actuator and the at least one second actuator has one or more shape memory material members, each actuator being structured and operatively connected to the other actuator so that an activation input provided to the one or more shape memory material members of one actuator causes the one or more shape memory material members of the one actuator to contract, thereby causing a distance between a portion of the one actuator and the other actuator to increase.

6. The lumbar support structure of claim 4, wherein the at least one second actuator comprises:
a second actuator base;
a second actuator push structure structured to be movable with respect to the second actuator base during morphing of the actuator; and
one or more massaging elements extending from the second actuator push structure.

7. The lumbar support structure of claim 4, wherein the at least one first actuator comprises:
a first actuator base; and
a first actuator push structure structured to be movable with respect to the first actuator base during morphing of the actuator,
wherein the at least one second actuator is mounted on first actuator push structure to provide a stacked configuration of the at least one second actuator on the at least one first actuator.

8. A seat including a lumbar support structure in accordance with claim 1 positioned in a lumbar region of the seat.

9. The lumbar support structure of claim 1, wherein the at least one actuator includes at least a first shape memory material member and a second shape memory material member electrically isolated from, and activatable independently of, the first shape memory material member.

10. The lumbar support structure of claim 9, wherein the at least a first shape memory material member is structured to as to generate a first push force when activated, and the second shape memory material member is structured to as to generate a second push force when activated, and wherein the second push force is different from the first push force.

11. The lumbar support structure of claim 1, wherein the at least one actuator comprises at least a first shape memory material member and a second shape memory material member electrically isolated from, and configured to be activatable independently of, the first shape memory material member.

12. The lumbar support structure of claim 11, wherein activation of the first shape memory material member causes generation of a first push force A in the at least one actuator, individual activation of the second shape memory material member causes generation of a second push force B, and simultaneous activation of both the first shape memory material and the second shape memory material causes generation of a push force equal to A+B.

13. The lumbar support structure of claim 11, wherein individual activation of the first shape memory material member causes generation of a first push force in the at least one actuator, and individual activation of the second shape memory material member causes generation of a second push force different from the first push force in the at least one actuator.

14. A lumbar support system, comprising:
a lumbar support structure including at least one actuator having one or more shape memory material members, the at least one actuator being structured so that an activation input provided to the one or more shape memory material members causes the one or more shape memory material members to contract, thereby causing an increase in a lumbar support force generated by the actuator;
a processor; and
a memory communicably coupled to the processor and storing a control module including computer-readable instructions that when executed by the processor cause the processor to control provision of the activation input to the one or more shape memory material members.

15. The lumbar support system of claim 14, wherein the control module includes computer-readable instructions that when executed by the processor cause the processor to control provision of the activation input to the one or more shape memory material members by controlling a flow of electrical energy from a power source(s) to the one or more shape memory material members.

16. The lumbar support system of claim 14, further comprising a plurality of actuators, and wherein the control module includes computer-readable instructions that when executed by the processor cause the processor to control provision of the activation input to one or more shape memory material members of the plurality of actuators so as to activate and/or deactivate the actuators of the plurality of actuators individually or in one or more groups.

17. The lumbar support system of claim 14, wherein the control module includes computer-readable instructions that when executed by the processor cause the processor to control provision of the activation input to the one or more shape memory material members responsive to a user input.

18. The lumbar support system of claim 14, wherein the control module includes computer-readable instructions that when executed by the processor cause the processor to control provision of the activation input to the one or more shape memory material members so as to maintain the at least one actuator in an activated condition.

19. The lumbar support system of claim 18, wherein the control module includes computer-readable instructions that when executed by the processor cause the processor to control operation of a locking mechanism operatively connected to the actuator and structured to maintain the actuator in the activated condition.

20. The lumbar support system of claim 14, further comprising a seat and wherein the lumbar support structure is secured to an independently adjustable lumbar support positioned inside a back portion of the seat.
